(19) United States
(12) Patent Application Publication
(10) Pub. No.: US 2024/0171472 A1
(43) Pub. Date: May 23, 2024

(54) NETWORK ANALYTICS TRACING, AND ROLLBACK FOR STABLE CONSUMPTION OF ANALYTICS OUTPUT

(71) Applicant: HUAWEI TECHNOLOGIES CO., LTD., Shenzhen (CN)

(72) Inventors: Clarissa MARQUEZAN, Munich (DE); Ramya PANTHANGI MANJUNATH, Munich (DE); Apostolos KOUSARIDAS, Munich (DE); Chan ZHOU, Munich (DE); Riccardo TRIVISONNO, Munich (DE)

(73) Assignee: HUAWEI TECHNOLOGIES CO., LTD., Shenzhen, GD (CN)

(21) Appl. No.: 18/425,146

(22) Filed: Jan. 29, 2024

Related U.S. Application Data
(63) Continuation of application No. PCT/EP2021/071360, filed on Jul. 30, 2021.

(51) Int. Cl. H04L 41/14; H04L 41/16

(52) U.S. Cl. CPC H04L 41/14; H04L 41/16

(57) ABSTRACT

According to a new generation mobile network, the generation of analytics information in the mobile network, and a network analytics tracing entity and network analytics training entity configured to obtain and perform one or more rollback actions, tracing an analytics ID or one or more analytics outputs for the analytics ID, an inference or training rollback for an unstable analytics ID or for at least one unstable analytics output for the analytics ID are concerned. To this end, a network analytics tracing entity configured to: obtain an indication with information to activate a tracing of one or more analytics outputs for an analytics ID, and/or a tracing of the analytics ID, and provide a rollback notification including one or more rollback actions related to the analytics ID, if an output for the analytics ID is unstable and/or if the analytics ID is unstable.

### CROSS-REFERENCE TO RELATED APPLICATIONS

This application is a continuation of International Application No. PCT/EP2021/071360, filed on Jul. 30, 2021, the disclosure of which is hereby incorporated by reference in its entirety.

### TECHNICAL FIELD

The embodiments relate to a new generation mobile network, e.g., a 5^{th} generation (5G) mobile network, and to the generation of analytics information in the mobile network. The embodiments may be concerned with tracing an analytics identifier (ID) or one or more analytics outputs for the analytics ID. Further, the embodiments may be concerned with an inference or training rollback for an unstable analytics ID or for at least one unstable analytics output for the analytics ID. To this end, the embodiments present presents a network analytics tracing entity, a network analytics inference entity, a network analytics training entity, a network analytics consumer entity, a network analytics management entity, and methods for these entities.

### BACKGROUND

In a current mobile network, the Network Data Analytics Function (NWDAF) provides various analytics functions that can be used by several Network Functions (NF) to improve or make their decisions (e.g., analytics information that may be provided by the NWDAF to support the NFs to assist on Radio Access Technology (RAT) and frequency selection). Each analytics function has its own ID (analytics ID) that a NF function can use to indicate the analytics (output) that it requests by the NWDAF. As shown in FIG. 1, the NWDAF consists of two functionalities that can be part of the same NWDAF entity or can be placed at different NWDAF entities: a) inference that provides analytics and/predictions, using trained machine learning models; b) training that generates the machine learning models using collected data and/or a training data set. FIG. 1 shows an example of analytics ID consumption for Session Management (SM).

The quality of the NWDAF analytics is affected by various factors e.g., the quality and amount of the collected data to train the mode, configuration of machine learning model etc. Consequently, the quality of an NWDAF machine learning model can affect the network performance or network status, according to the usage of an NWDAF analytics. A successful (or an efficient, or reliable) analytics ID can lead or maintain a stable network status, while a less successful (or an inefficient, or unreliable) analytics ID can lead to or create unstable network status. For a stable network status, system Key Performance Indicators (KPIs) and/or metrics are kept within the expected pattern of usage (or improved). For an unstable network status, the KPIs and/or metrics of system load remain at expected patterns, but the KPIs indicating situations are unstable (or decrease from the expected pattern).

It is thus important to detect and address cases of an analytics ID that leads to an unstable network status. However, the time to detect and fix an analytics ID leading to an unstable network status is a variable that depends on the NWDAF black box logic. It can take seconds (e.g., if it is a model reselection) or it can take days (e.g., needing data collection with enough amount of data, or having human intervention for model tuning by ML Analysts).

### SUMMARY

The embodiments are based on the following further considerations with reference to FIG. 2, which shows an example of an unstable network status, due to the impact of NF decision using an analytics ID.

Currently, if an NF stops consuming an analytics ID (e.g., while an NWDAF fix it) this leads to major gap in the logic of the NF operation, that again leads to major discrepancies in its decision-making, with the potential to aggravate the deterioration of the network status or to lead to NWDAF collecting distorted data, because the decisions affecting the network status are not reflecting the entire logic of the NF. If the NF keeps consuming the same analytics ID with a problem, the NF will keep taking decisions that lead to an unstable network status. If the NWDAF inference simply reselects ML models (e.g., from its local information or by querying an NWDAF training), it can only become aware of problems with the analytics ID via cycles of data collection. Hence, none of the above alternative options constitutes a valid or effective solution to the above-described problem.

That is, there is the problem that the NWDAF inference may not be able to keep providing an analytics ID output that leads to stable network status. Further, the NWDAF training may not become aware fast enough of problems in the analytics IDs, and thus cannot support the fixing of the configuration/generation of an analytics ID output leading to unstable network status.

The current lack of a solution for this problem leads further to the following key problem. There will exist an endless mismatch between the network status considered in a repaired analytics ID and the network status when the NF resumes consuming such repaired analytics after it stopped consuming the analytics output for the analytics ID considered unstable during the period, in which NWDAF was repairing the unstable analytics ID. When the NF stops consuming an analytics ID (due to need for repair), the NF will have its decision logic changed (by not considering anymore the analytics ID output) and this may have effects in the network status. In parallel, the NWDAF will be using network status data to repair the unstable analytics ID, when this data reflects only part of the actual behavior of the network status influenced by the NF, because the data the NWDAF may use to repair the analytics ID does not reflect the same scenario when the analytics ID is again consumed by the NF.

Conventional solutions so far focus on (a) detecting the reliability of labels in the training samples. However, this is an issue only to the training phase, and only this, is neither able to detect the effect of a trained model (i.e., analytic ID) in the system KPIs nor able to trace the wrong labels to changes in the network status. Further, the solutions focus on (b) collecting batches of data from multiple sources in order to allow rollback to a previously collected batch of data. However, such a solution does not consider mechanisms to detect unreliable/unstable analytics IDs or control configurations of an analytics ID. Further, the solutions focus on (c) executing rollback to previous known good state upon receiving a request for resources in a computer system (where resources are defined as databases, load balancers, scaling group machines). However, solutions to rollback configurations of analytics IDs are not considered. Moreover, an analytics ID is not a computer resource. An analytics ID can be broadly defined as a system property.

In 3GPP, although no solution has been defined, the embodiments provide for the possibility of NWDAF being capable of receiving direct feedback from NFs consuming the analytics IDs outputs. This can allow the NWDAF to detect performance degradation without requiring significant amount of data collection. However, the issue of what happens with the NFs during an ongoing analytics subscriptions when the NWDAF detects a performance degradation and is trying to improve the analytics ID output is not considered.

In view of the above, the embodiments aim to solve the identified problems, and to provide an improved solution that avoids the above-mentioned drawbacks. An objective is to ensure that an analytics ID, or one or more analytics outputs for the analytics ID, lead to a stable network status. Another objective is to enable an analytics training to become aware quickly of problems in any unstable analytics IDs, or in at least one unstable analytics output for the analytics ID.

These and other objectives are achieved by the embodiments as described herein. Advantageous implementations of the embodiments are further defined throughout.

The embodiments introduce a methods, interfaces, and entities for enabling the tracing of an analytics ID, or of one or more analytics outputs for the analytics ID. The tracing may be performed by a network analytics tracing entity, and can enable detecting an unstable analytics ID or an unstable analytics output for the analytics ID. This can further enable the reverting (or rollback) of a configuration of the unstable analytics ID or the unstable analytics output for the analytics (at inference and/or training), such as a rollback to a last known stable network state in the mobile system. This allows a network analytics inference entity (e.g., the NWDAF inference) to keep providing an analytics ID output to one or more network analytics consumer entities (e.g., NWDAF consumers), which leads to a stable network status. In addition, this enables supporting a network analytics training entity (e.g., the NWDAF training) to become aware of problems in the configuration and/or generation of an analytics ID, or one or more analytics outputs for the analytics ID, which could lead to an unstable network status.

A first aspect provides a network analytics tracing entity, configured to: obtain an indication with information to activate a tracing of one or more analytics outputs for an analytics identifier, ID, and/or a tracing of the analytics ID; and provide a rollback notification related to the analytics ID, if at least one output for the analytics ID is unstable and/or if the analytics ID is unstable, where the rollback notification includes one or more of: the at least one unstable analytics output for the analytics ID and/or the analytics ID, where the rollback notification is provided to a network analytics consumer entity, a network analytics inference entity, or a network analytics training entity; an inference rollback action for the at least one unstable analytics output for the analytics ID and/or for the analytics ID, where the rollback notification is provided to the network analytics inference entity; a training rollback action for the at least one unstable analytics output for the analytics ID and/or for the analytics ID, where the rollback notification is provided to the network analytics training entity.

The network analytics tracing entity may initiate the tracing of the analytics ID, and/or the one or more analytics output of the analytics ID, and may thus identify unstable configurations. The tracing entity can further provide the rollback notification with the respective rollback actions, which allows reverting the analytics ID or the analytics outputs to a stable configuration. Thus, the tracing entity helps to ensure that the analytics ID, and/or the one or more analytics outputs for the analytics ID, lead to a stable network status. Further, it may help a network analytics training entity to become aware faster of problems with the unstable analytics ID and/or the at least one unstable analytics output for the analytics ID.

In an implementation form of the first aspect, the inference rollback action is an action for changing an inference configuration about the at least one unstable analytics output and/or about the analytics ID at the network analytics inference entity; and/or the training rollback action is an action for changing a training configuration about the at least one unstable analytics output and/or about the analytics ID at the network analytics training entity.

The changing of the inference configuration and/or of the training configuration can revert the unstable analytics ID and/or the at least one unstable analytics output for the analytics ID back to a stable state.

In an implementation form of the first aspect, the network analytics tracing entity is configured to trace the one or more analytics outputs for the analytics ID and/or trace the analytics ID, based on the indication with the information to activate the tracing; and provide the rollback notification based on the tracing of the one or more analytics outputs for the analytics ID and/or the analytics ID.

The tracing entity may identify the unstable analytics ID and/or at least one unstable analytics output for the analytics ID. The tracing entity may also identify a reason for the instability. The rollback action(s) in the rollback notification may be selected based on the tracing, i.e., the identification of the instability and optionally the reason. Thus, the best possible rollback action(s) can be provided with the rollback notification.

In an implementation form of the first aspect, the network analytics tracing entity is further configured to receive a rollback status notification, where the rollback status notification includes at least one of a status of the inference rollback action executed by the network analytics inference entity and a status of the training rollback action executed by the network analytics training entity.

Thus, the tracing entity of the first aspect may be informed about whether the rollback action was, for instance, successful or not. Further, the tracing entity may thus gather information for future decisions. For instance, if another instability of the same analytics ID and/or the at least one unstable output for the analytics ID occurs, it may provide a further rollback notification taking into account the previously received rollback status.

In an implementation form of the first aspect, the network analytics tracing entity is further configured to provide at least one of the following: an analytics status notification indicating at least one of that the one or more analytics outputs for the analytics ID are stable and that the analytics ID is stable; a confirmation that the at least one unstable analytics output for the analytics ID is unstable; an inference tracing activation indication with information to activate a tracing of an inference configuration about at least one of the one or more analytics outputs for the analytics ID and the analytics ID; a training tracing activation indication to activate a tracing of a training configuration about at least one of the one or more analytics outputs for the analytics ID and the analytics ID.

This may enable other entities to adapt to the unstable analytics ID and/or unstable analytics output. Further, this may start the tracing of the inference and/or training configuration, for example, at a network analytics training entity and network analytics inference entity, respectively.

In an implementation form of the first aspect, the network analytics tracing entity is further configured to generate analytics tracing information for the one or more analytics outputs for the analytics ID and/or for the analytics ID and to determine the inference rollback action and/or the training rollback action based on the analytics tracing information, where the analytics tracing information includes any of the following: the analytics ID, an association of the analytics ID to the one or more analytics outputs for the analytics ID, one or more quality indications about at least one of the one or more analytics outputs for the analytics ID and the analytics ID, an inference configuration about the analytics ID and/or about the one or more analytics outputs for the analytics ID a training configuration about the analytics ID and/or about the one or more analytics outputs for the analytics ID.

The analytics tracing information is also referred to as “analytics tracing data structure”. The analytics tracing information can be used to maintain all information available regarding the analytics ID(s) and/or the one or more analytics outputs for the analytics ID(s) at the tracing entity. It may also maintain respective training and/or inference configurations, and thus supports the selection of the best rollback action(s) by the tracing entity. The tracing entity may have analytics tracing information for many analytics IDs and respective analytics outputs for these analytics IDs.

In an implementation form of the first aspect, the analytics tracing information further includes at least one of a status of the inference rollback action, a status of the training rollback action, one or more inference rollback actions, and one or more training rollback actions associated with the analytics ID and/or associated with one or more analytics outputs for the analytics ID.

This further supports the selection of the rollback action(s) by the tracing entity, in case that the same analytics ID and/or at least one analytics output for the analytics ID is unstable once more.

In an implementation form of the first aspect, the analytics tracing information further includes an association of the analytics ID and/or of the one or more analytics outputs for the analytics ID to at least one of: a timestamp; an identification of the network analytics inference entity; an identification of the network analytics training entity; an identification of the network analytics consumer entity; an identification of the one or more analytics outputs for the analytics ID.

This further facilitates the operation of the tracing entity, such as the tracing of various analytics IDs and analytics outputs for analytics IDs, and the selection of rollback action(s) in case of instabilities.

In an implementation form of the first aspect, the step of obtaining the indication with the information to activate the tracing of the one or more analytics outputs for the analytics ID and/or the tracing of the analytics ID includes one of the following: receiving a message including the indication with the information to activate the tracing of the one or more outputs for the analytics ID and/or the tracing of the analytics ID, from at least one of the network analytics consumer entity, the network analytics inference entity, and the network analytics training entity; receiving a configuration including the indication with the information to activate the tracing of the one or more analytics outputs for the analytics ID and/or the tracing of the analytics ID.

That is, the tracing entity may either be sent the information to activate the tracing by another entity or may be configured with this information to activate the tracing.

In an implementation form of the first aspect, the information to activate the tracing of the one or more analytics outputs for the analytics ID and/or the tracing of the analytics ID includes at least of one: a flag, where the flag defines when to start the tracing for the one or more analytics outputs for the analytics ID and/or the tracing of the analytics ID; the analytics ID and the flag, where the flag defines when to start the tracing of the one or more analytics outputs for the analytics ID and/or the tracing of the analytics ID.

Thus, the tracing can be triggered for an analytics ID at a time.

A second aspect provides a network analytics inference entity, configured to: obtain an inference rollback action for at least one analytics output for an analytics ID and/or for the analytics ID; and execute the inference rollback action, where executing the inference rollback action includes at least one of: changing an inference configuration about the at least one analytics output for the analytics ID and/or about the analytics ID; determining and setting a new inference configuration about the at least one output for the analytics ID and/or about the analytics ID; selecting a new analytics model for the at least one analytics output for the analytics ID and/or for the analytics ID; deactivating an analytics model for the at least one analytics output for the analytics ID and/or for the analytics ID.

The network analytics inference entity of the second aspect is an entity configured to perform analytics inference (e.g., NWDAF inference). Thereby, it may output one or more analytics outputs for respectively one or more analytics IDs.

By executing the inference rollback action(s), the inference entity helps bringing the network back to a stable status, ensuring that a stable analytics ID and/or stable analytics outputs for the analytics ID are provided. Thereby, the inference entity may select from different options, in order to revert the stable status.

In an implementation form of the second aspect, obtaining the inference rollback action includes one of: receiving a rollback notification related to the analytics ID from a network analytics tracing entity, where the rollback notification includes the inference rollback action for the at least one analytics output for the analytics ID and/or for the analytics ID; being configured with the inference rollback action; receiving a rollback notification from the network analytics tracing entity, the rollback notification includes at least one analytics output for the analytics ID and/or the analytics ID, and determining the inference rollback action based on the rollback notification.

That is, there are different possibilities how the inference entity becomes aware of the inference rollback action it should execute. The tracing entity of the first aspect may configure the inference entity with the inference rollback action.

In an implementation form of the second aspect, the network analytics inference entity is further configured to provide, based on the obtained or executed inference rollback action, at least one of the following to a network analytics consumer entity, a network analytics training entity, or another network analytics inference entity: a notification that at least one analytics output for the analytics ID is unstable and/or that the analytics ID is unstable; a confirmation that at least one unstable analytics output for the analytics ID is unstable and/or that the analytics ID is unstable; an analytics status notification indicating at least one of that one or more analytics outputs for the analytics ID are stable and that the analytics ID is stable.

In this way, the other entity or entities may become aware of stable and/or unstable analytics IDs and analytics outputs for analytics IDS and may accordingly adapt their behaviour or use of the analytics outputs.

In an implementation form of the second aspect, the network analytics inference entity is further configured to provide an indication with information to activate a tracing of one or more analytics outputs for the analytics ID and/or a tracing of the analytics ID to the network analytics tracing entity.

Thus, the inference entity may be the one that triggers the network analytics tracing entity. The inference entity may select the analytics ID(s) and/or analytics outputs for these analytics ID(s), which are to be traced. It may do this, for instance, if it suspects that there is an unstable analytics ID or analytics output, for instance, if an inference result is not as expected.

In an implementation form of the second aspect, selecting the new analytics model for the at least one analytics output for the analytics ID and/or for the analytics ID includes providing a selection indication related to an unstable analytics ID and/or related to at least one unstable analytics output for the analytics ID to a network analytics training entity, the selection indication including at least one of: a notification that the at least one analytics output for the analytics ID is unstable and/or that the analytics ID is unstable; a request for selecting the new analytics model, the request including a reason for selecting the new analytics model; a request for retraining the analytics model to produce the new analytics model, the request including a reason for retraining the analytics model.

With the new analytics model, the stability of the analytics ID and/or the analytics output(s) for the analytics ID may be restored.

In an implementation form of the second aspect, the network analytics inference entity is further configured to receive an indication to reactivate a previously suspended subscription for at least one analytics output for the analytics ID and/or for the analytics ID from a network analytics consumer entity.

This may, for instance, be the case if an analytics ID and/or one or more analytics outputs for the analytics ID, which were identified to be unstable, have been rolled back to stable status (last stable version, for example).

In an implementation form of the second aspect, the network analytics inference entity is further configured to provide a rollback status notification to the network analytics tracing entity, where the rollback status notification includes a status of the inference rollback action executed by the network analytics inference entity.

Thus, the tracing entity may become aware of the status of the inference rollback action and may take this into account as described above.

In an implementation form of the second aspect, the network analytics inference entity is further configured to obtain an indication with information to activate a tracing of one or more analytics outputs for the analytics ID and/or a tracing of the analytics ID; and generate an inference configuration about the analytics ID and/or about at least one analytics output for the analytics ID based on the indication with the information to activate the tracing.

In an implementation form of the second aspect, the network analytics inference entity is further configured to provide the inference configuration about the analytics ID and/or about the at least one analytics output for the analytics ID to the network analytics tracing entity.

As the inference configuration may be provided to the tracing entity, it may facilitate the selection of an inference rollback action for addressing the instabilities of the analytics ID and/or analytics outputs for the analytics ID.

A third aspect provides a network analytics training entity, configured to: obtain a training rollback action for at least one analytics output for an analytics ID and/or for the analytics ID; and execute the training rollback action, where executing the training rollback action includes at least one of: changing a training configuration about the at least one analytics output for the analytics ID and/or about the analytics ID; selecting and setting a new training configuration about the at least one analytics output for the analytics ID and/or about the analytics ID; performing a retraining or a reselection of an analytics model for the at least one analytics output for the analytics ID and/or for the analytics ID; deactivating an analytics model for the at least one analytics output for the analytics ID and/or for the analytics ID.

The network analytics training entity of the third aspect is an entity configured to perform analytics training (e.g., NWDAF training). Thereby, it may train one or more analytics models, which may be used by a network analytics inference entity to provide analytics output(s). The network analytics training entity and the network analytics inference entity may be combined in one entity (e.g., the NWDAF).

By executing the training rollback action(s), the training entity helps bringing the network back to a stable status, ensuring that a stable analytics ID and/or stable analytics outputs for the analytics ID are provided. Thereby, the training entity may select from different options, in order to revert the stable status.

In an implementation form of the third aspect, obtaining the training rollback action includes one of receiving a rollback notification for the at least one analytics output for the analytics ID and/or for the analytics ID from a network analytics tracing entity, where the rollback notification includes the training rollback action for the at least one analytics output for the analytics ID and/or for the analytics ID; being configured with the training rollback action.

That is, there are different possibilities how the training entity becomes aware of the training rollback action it should execute. The tracing entity of the first aspect may configure the training entity with the training rollback action.

In an implementation form of the third aspect, the network analytics training entity is further configured to provide, based on the obtained or executed training rollback action, at least one of the following to a network analytics consumer entity, the network analytics inference entity, or another network analytics training entity: a notification that the at least one analytics output for the analytics ID is unstable and/or that the analytics ID is unstable; a confirmation that at least one unstable analytics output for the analytics ID is unstable and/or that the analytics ID is unstable; an analytics status notification indicating at least one of that one or more analytics outputs for the analytics ID are stable and/or that the analytics ID is stable; information regarding the training rollback action; an indication of a reason for the retraining, or the reselection, or the deactivation, of the analytics model.

In this way, the other entity or entities may become aware or stable and/or unstable analytics IDs and analytics outputs for analytics IDS and may accordingly adapt their behaviour or use of the analytics outputs.

In an implementation form of the third aspect, the network analytics training entity is further configured to obtain, from the network analytics inference entity or another network analytics training entity, an indication of the reason for the retraining or the reselection of the analytics model, the indication of the reason including at least one of: a notification that the at least one analytics output for the analytics ID is unstable and/or that the analytics ID is unstable; a request for selecting the new analytics model; a request for retraining the analytics model to produce the new analytics model.

With the new analytics model, the stability of the analytics ID and/or the analytics output(s) for the analytics ID may be restored.

In an implementation form of the third aspect, the network analytics training entity is further configured to determine, based on the obtained indication of the reason, a training configuration about the analytics model for the at least one analytics output for the analytics ID and/or about the analytics ID.

In an implementation form of the third aspect, the network analytics training entity is further configured to provide to another network analytics training entity, an indication with information to activate a tracing of one or more analytics outputs for the analytics ID and/or a tracing of the analytics ID.

In an implementation form of the third aspect, the network analytics training entity is further configured to provide a rollback status notification to the network analytics tracing entity, where the rollback status notification includes a status of the training rollback action executed by the network analytics inference entity.

Thus, the tracing entity may become aware of the status of the training rollback action and may take this into account as described above.

In an implementation form of the third aspect, the network analytics training entity is further configured to: obtain an indication with information to activate a tracing of one or more analytics outputs for an analytics ID and/or a tracing of the analytics ID; and generate a training configuration about the one or more analytics outputs for the analytics ID and/or for the analytics ID, based on the indication with the information to activate the tracing.

In an implementation form of the third aspect, the network analytics training entity is further configured to provide the training configuration about the one or more analytics outputs for the analytics ID and/or for the analytics ID to the network analytics tracing entity.

As the training configuration may be provided to the tracing entity, the training configuration may facilitate the selection of an inference rollback action for addressing the instabilities of the analytics ID and/or analytics outputs for the analytics ID.

A fourth aspect provides a network data analytics consumer entity, configured to provide, to a network analytics tracing entity or a network analytics inference entity, an indication with information to activate a tracing of one or more analytics outputs for an analytics ID and/or a tracing of the analytics ID.

Thus, the consumer entity (e.g., NWDAF consumer) may trigger the tracing of the analytics ID and/or analytics outputs for the analytics ID and may thus support the rollback in case of instabilities.

In an implementation form of the fourth aspect, the network data analytics consumer entity is further configured to provide an indication to reactivate a previously suspended subscription for the one or more analytics outputs for the analytics ID and/or for the analytics ID to the network analytics inference entity.

For instance, in a case where a previously unstable analytics ID or analytic(s) outputs for the analytics ID are stable once more.

In an implementation form of the fourth aspect, the network analytics consumer entity is further configured to obtain, from the network analytics tracing entity or the network analytics inference entity, at least one of the following: a notification that at least one analytics output for the analytics ID is unstable and/or that the analytics ID is unstable; a confirmation that at least one unstable analytics output for the analytics ID is unstable; an analytics status notification indicating at least one of that one or more analytics outputs for the analytics ID are stable and/or that the analytics ID is stable.

Thus, the network analytics consumer entity may adapt its behavior accordingly, such as its use of the analytics ID(s) and/or analytics output(s) for the analytics ID(s). For instance, it may suspend consumption and/or subscription of one or more unstable analytics IDs and/or one or more unstable analytics outputs for the one or more analytics IDs.

In an implementation form of the fourth aspect, the network analytics consumer entity is further configured to provide one or more quality indications about at least one of the one or more analytics outputs of the analytics ID and/or about the analytics ID, to the network analytics tracing entity.

This may enable the tracing entity to determine whether one or more analytics IDs and/or one or more analytics outputs for the one or more analytics IDs are unstable.

A fifth aspect provides a network analytics management entity, configured to perform a configuration to activate a tracing of one or more analytics outputs for an analytics ID and/or a tracing of the analytics ID; and/or configure analytics tracing information for the analytics ID; and/or perform a configuration to activate a collection of data for one or more quality indications about the one or more analytics outputs for the analytics ID and/or about the analytics ID.

Thus, the network analytics management entity may support the tracing entity in its tracing and may thus support the stability of the analytics outputs in the network.

A sixth aspect provides a method for a network analytics tracing entity, the method including: obtaining an indication with information to activate a tracing of one or more analytics outputs for an analytics identifier, ID, and/or a tracing of the analytics ID; and providing a rollback notification related to the analytics ID, if at least one output for the analytics ID is unstable and/or if the analytics ID is unstable, where the rollback notification includes one or more of: the at least one unstable analytics output for the analytics ID and/or the analytics ID, where the rollback notification is provided to a network analytics consumer entity, a network analytics inference entity, or a network analytics training entity; an inference rollback action for the at least one unstable analytics output for the analytics ID and/or for the analytics ID, where the rollback notification is provided to the network analytics inference entity; a training rollback action for the at least one unstable analytics output for the analytics ID and/or for the analytics ID, where the rollback notification is provided to the network analytics training entity.

The method of the sixth aspect corresponds to the tracing entity of the first aspect and may have implementation forms that correspond to the implementation forms of the first aspect.

Accordingly, the method of the sixth aspect and its implementation forms may achieve the same advantages as described above for the tracing entity of the first aspect and its implementation forms.

A seventh aspect provides a method for a network analytics inference entity, the method including: obtaining an inference rollback action for at least one analytics output for an analytics ID and/or for the analytics ID; and executing the inference rollback action, where executing the inference rollback action includes at least one of: changing an inference configuration about the at least one analytics output for the analytics ID and/or about the analytics ID; determining and setting a new inference configuration about the at least one output for the analytics ID and/or about the analytics ID; selecting a new analytics model for the at least one analytics output for the analytics ID and/or for the analytics ID; deactivating an analytics model for the at least one analytics output for the analytics ID and/or for the analytics ID.

The method of the seventh aspect corresponds to the inference entity of the second aspect and may have implementation forms that correspond to the implementation forms of the second aspect. Accordingly, the method of the seventh aspect and its implementation forms may achieve the same advantages as described above for the inference entity of the second aspect and its implementation forms.

An eighth aspect provides a method for a network analytics training entity, the method including: obtaining a training rollback action for at least one analytics output for an analytics ID and/or for the analytics ID; and executing the training rollback action, where executing the training rollback action includes at least one of: changing a training configuration about the at least one analytics output for the analytics ID and/or about the analytics ID; selecting and setting a new training configuration about the at least one analytics output for the analytics ID and/or about the analytics ID; performing a retraining or a reselection of an analytics model for the at least one analytics output for the analytics ID and/or for the analytics ID; deactivating an analytics model for the at least one analytics output for the analytics ID and/or for the analytics ID.

The method of the eighth aspect corresponds to the training entity of the third aspect and may have implementation forms that correspond to the implementation forms of the third aspect. Accordingly, the method of the eighth aspect and its implementation forms may achieve the same advantages as described above for the training entity of the third aspect and its implementation forms.

A ninth aspect provides a method for a network data analytics consumer entity, the method including providing, to a network analytics tracing entity or a network analytics inference entity, an indication with information to activate a tracing of one or more analytics outputs for an analytics ID and/or a tracing of the analytics ID.

The method of the ninth aspect corresponds to the consumer entity of the fourth aspect and may have implementation forms that correspond to the implementation forms of the fourth aspect. Accordingly, the method of the ninth aspect and its implementation forms may achieve the same advantages as described above for the consumer entity of the fourth aspect and its implementation forms.

A tenth aspect provides a method for a network analytics management entity, the method including: performing a configuration to activate a tracing of one or more analytics outputs for an analytics ID and/or a tracing of the analytics ID; and/or configuring analytics tracing information for the analytics ID; and/or performing a configuration to activate a collection of data for one or more quality indications about the one or more analytics outputs for the analytics ID and/or about the analytics ID.

The method of the tenth aspect corresponds to the management entity of the fifth aspect and may have implementation forms that correspond to the implementation forms of the fifth aspect. Accordingly, the method of the tenth aspect and its implementation forms may achieve the same advantages as described above for the management entity of the tenth aspect and its implementation forms.

An eleventh aspect provides a computer program including a program code for performing the method according to the sixth, seventh, eighth, ninth or tenth aspect or any of their implementation forms, when executed on a computer or processor.

A twelfths aspect provides a non-transitory storage medium storing executable program code which, when executed by a processor, causes the method according to the sixth, seventh, eighth, ninth or tenth aspect or any of their implementation forms to be performed.

It has to be noted that all entities, elements, units, and means could be implemented in the software or hardware elements or any kind of combination thereof. All steps which are performed by the various entities described in the embodiments as well as the functionalities described to be performed by the various entities are intended to mean that the respective entity is adapted to or configured to perform the respective steps and functionalities. Even if, in the following description of the embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### BRIEF DESCRIPTION OF THE DRAWINGS

The above described aspects and implementation forms will be explained in the following description of the embodiments in relation to the enclosed drawings, in which

FIG. 1 shows an example of analytics ID consumption for Session Management (SM).

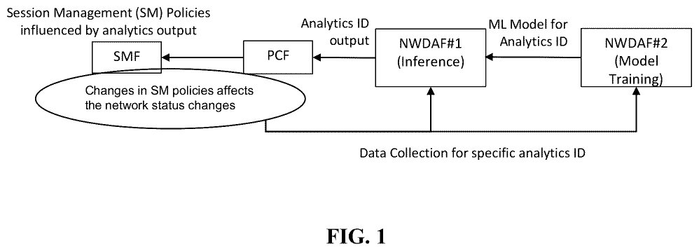

FIG. 2 shows an example of an unstable network status, due to the impact of NF decision using an analytics ID.

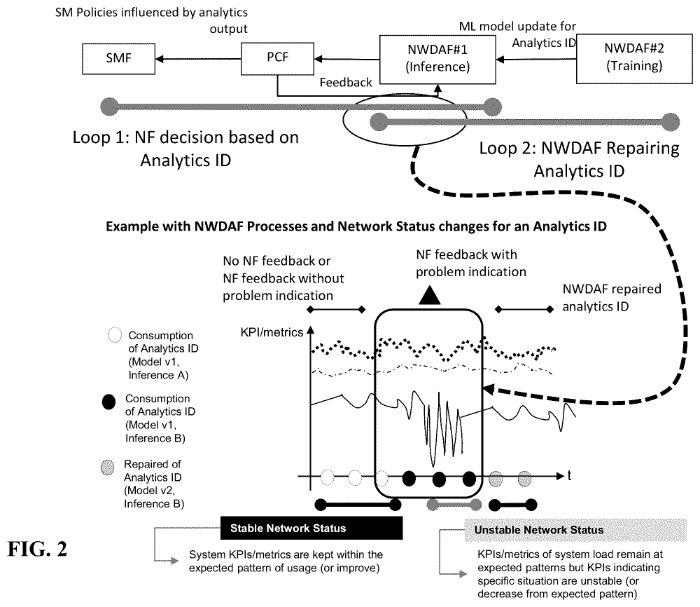

FIG. 3 illustrates various entities according to the embodiments.

FIG. 4 shows stages 1 and 4 of a procedure performed by entities according to the embodiments.

FIG. 5 shows stages 2, 3 and 5 of the procedure of FIG. 4 performed by entities according to the embodiments.

FIG. 6 shows a first alternative implementation of entities according to embodiments.

FIG. 7 shows a second alternative implementation of entities according to embodiments.

FIG. 8 shows a method according to an embodiment for a network analytics tracing entity.

FIG. 9 shows a method according to an embodiment for a network analytics inference entity.

FIG. 10 shows a method according to an embodiment for a network analytics training entity.

FIG. 11 shows a method according to an embodiment for a network analytics consumer entity.

FIG. 12 shows a method according to an embodiment for a network analytics management entity.

### DETAILED DESCRIPTION OF EMBODIMENTS

In this section, various terms used in the summary part and the detailed description of the embodiments are explained and/or defined. The explanations and/or definitions are valid throughout the embodiments.

Unstable Analytics ID: one or more analytics outputs of an analytics ID (e.g., an analytics type) and/or an analytics ID that are associated with unstable network status. Synonyms of the term unstable analytics ID include: unstable analytics output, inefficient analytics output (or ID, or type), unreliable analytics output (or ID, or type), low accuracy analytics output (or ID, or type). The one or more analytics outputs of an analytics ID and/or an analytics ID that is considered unstable analytics ID are associated with indications of low network performance. Examples of these indications are: feedback from an NF consumer (NF Feedback), analytics ID grades, notification about an analytics ID grade that deviates from defined/configured/expected threshold values.

Stable Analytics ID: one or more analytics outputs of an analytics ID (e.g., an analytics type) and/or analytics ID that leads to (e.g., that is related to or associated with) stable network status. Synonyms of the term stable analytics ID are: stable analytics output, efficient analytics output (or ID, or type), reliable analytics output (or ID, or type), high accuracy analytics output (or ID, or type).

Network Status: is the one or more information that quantify the network performance. Examples of information that can be used for representing the network status are KPIs and/or metrics associated with a network.

Stable Network Status: defines a network status where the KPIs and/or metrics related to the network are kept within the expected pattern of usage (or improved).

Unstable Network Status: defines the network status where KPIs and/or metrics related to the overall performance of the network remain at expected patterns, but KPIs and/or metrics indicating situations are oscillating out of expected pattern or decrease from expected pattern. Examples of overall performance metrics are: total number of accepted PDU sessions, average link throughput, total number of UE registrations per slice. Examples of KPIs or metrics are: number of rejected sessions per type of application; link usage per group of UEs. KPIs or metrics related to overall performance of the network can be generally related to performance information that can be obtained from OAM, Management Entities. While the KPIs and/or metrics can be generally related to performance information that can be obtained from Control Plane Entities (e.g., Session Management Function (SMF), Policy Control Function (PCF), Access and Mobility Management Function (AMF)).

Information about unstable analytics ID: defines the one or more data and/or parameters and/or properties, and/or configurations of an analytics ID (e.g., analytics type, analytics output(s)) at inference and/or at training where this set is associated with an unstable analytics ID.

Information on how to repair an unstable analytics ID: defines the set of data and/or parameters and/or properties, and/or configurations of an analytics ID (e.g., analytics type, analytics output(s)) at inference and/or training associated with a last known stable network state in the mobile system.

Tracing of an analytics ID: denotes the process executed for associating an analytics ID to analytics output(s), an indication of the quality of usage of the analytics (ID and/or output(s)) in the mobile network, and/or the configuration at inference and/or training for such analytics ID. In other words, is the process for creating an Analytics Tracing Data Structure (ATDS) for a given analytics ID and creating over time the ATDS records for such an analytics ID.

Indication for analytics ID tracing activation: a message that contains the analytics ID tracing activation.

Analytics ID tracing activation: one or more parameters or information that denotes that the tracing of an analytics ID needs to be started. Examples of these parameters are a flag (e.g., tracing flag or rollback flag), a tuple with analytics ID and flag.

Indication of inference tracing activation: one or more parameters or information that denotes the tracing of inference configurations for an analytics (ID and/or output(s) needs to be started. For instance, this one or more parameters may indicate to the Inference NF that it needs to create Analytics Information Configuration Information (AICI) for the indicated analytics and provide such information to the network analytics tracing entity.

Indication of training tracing activation: One or more parameters or information that denotes the tracing of training configurations for an analytics (ID and/or output(s) needs to be started. For instance, this one or more parameters may indicate to the training NF that it needs to create ATCI information for the indicated analytics and provide such information to the Analytics Tracing Entity.

Configuration of analytics ID tracing activation: one or more information provided by a Management Entity (e.g., Operations, Administration and Maintenance (OAM)) that defines that the tracing of an analytics ID needs to be started.

Analytics output: one or more information that denotes the result of a generated, calculated, predicted instance of an analytics ID or type. Different analytics IDs have a different set of information denoting the analytics output. For instance, and analytics ID such as “Observed Service experience information” as defined in 3GPP TS 23.288 Release 17 defines that the output for such analytics ID is the set of the following information: S-NSSAI, Slice instance service experiences (0 . . . max), and for each of the NSIIDs related to an S-NSSAI there are other information such as: NSIID, Slice instance service experiences (0 . . . max), SUPI List, (0 . . . SUPImax), Estimated percentage of UEs with similar service experience, etc.

Analytics ID or Analytics Type: is a type of an analytics that can be generated by an Inference NF (e.g., NWDAF). For instance, the Observed Service experience information, Slice Load level information, Network Performance information, etc.

ATDS Record: an Analytics Tracing Data Structure (ATDS) record defines a network state at a given point in time when using a given analytics (e.g., analytics ID or analytics type or analytics output(s)). An ATDS record may be a tuple that indicates a mapping, at a given point in time, of an analytics ID to at least one of the following: one or more analytics output identifications and/or one or more analytics output, an indication of the quality of usage of the analytics (ID and/or output(s)) in the mobile network (e.g., Analytics ID Grade Information (AidGI) or unstable analytics ID information (UAiDI) for analytics output instance(s) or a Network Function (NF) feedback), and inference and/or training configuration information (e.g., AICI and/or ATCI) for the analytics output(s) or analytics IDs. Optionally the ATDS record can also include the rollback status and the analytics rollback actions.

Last known stable network state: a network state (e.g., ATDS record) at a given point in time when using a given analytics (e.g., analytics ID or analytics type or analytics output(s)) with the most appropriated Analytics Inference Configuration Information (AICI) and/or Analytics Training Configuration Information (ATCI) for analytics (ID and/or output(s)).

Analytics Rollback Actions: one or more information that define the possible actions that can be taken in order to change, revert, reconfigure the configuration associated with an analytics (e.g., analytics output(s) or analytics ID, or analytics type). Examples of this information and how they denote an action are described as follows:
One set of information is related to the old/current configuration, parameters, properties associated with an analytics (ID and/or output(s)) and a second set of information is related to the new possible configuration, parameters, properties associated with an analytics (ID and/or output(s)). This two sets of information defines that an action of replacing the old information with the new information should be executed.
Only one set of information related to the new configuration, parameters, and properties associated with an analytics (ID and/or output(s)). This denotes that the new information should be used to replace the existing one related to the analytics (ID and/or output(s)).
Only one set of information related to the old/current configuration. This denotes that an action for rollback or reconfiguration or repairing the analytics was not identified.

Rollback Status Notification: one or more information describing the results of performing Analytics Rollback Actions. Examples of the set of information describing the results of the actions are the following:
Successful rollback, optionally indicating whether the actions and/or configurations included in the Inference Rollback Notification or Training Rollback Notification have been implemented (e.g., used to change the configuration) or if different actions and/or configurations from the included in Inference Rollback Notification or Training Rollback Notification have been used, optionally indicating the different actions and/or configurations used.
Unsuccessful rollback, optionally indicating whether the indications of actions and/or configurations included in the Inference Rollback Notification or Training Rollback Notification have not been implemented (e.g., suggested configuration was not able to be used).
No rollback, which indicates that the one or more suggested Analytics Rollback Actions by the Analytics Tracing Entity were not used.

Analytics Status Notification: the information defining an analytics (ID and/or analytics output(s)) is considered as stable Analytics ID, which means that there is no problem with the analytics, or that the analytics is not anymore considered stable Analytics ID, which means there is problem with the analytics.

Indication of the quality of usage of the analytics: the information that defines the quality of an analytics ID (or analytics type) and/or analytics output(s) in relationship to the network of such analytics (analytics ID or analytics type, and/or analytics output(s)).

Analytics ID Performance Information (API): the information that includes the KPIs, metrics to be monitored and associated with a consumed analytics (ID and/or analytics output(s)), optionally for a consumer of such analytics (e.g., Analytics Consumer). The API serves as input for the AidGI calculation and support the identification of the effect of an analytics ID consumption in the changes of network status.

Analytics ID Grade Information (AidGI): one or more information that quantifies, e.g., in the format of a grade the effects of a consumed analytics (ID and/or output(s) on the changes in network status after the consumption of analytics ID. Examples of the set of information including the AidGI are any of the following:
Identification of AidGI
Identification of Analytics ID type: the type analytics ID for which a grade has to be calculated
(List of) Identification of analytics ID output: identification of the one or more analytics output information for the analytics ID that were consumed in the interval of time for the grade calculation
Grade Value: a single value that represents how the APIs monitored for the consumed analytics ID diverge from the expected pattern of network status. For instance:
   Grade value can be a real number between 1 and −1, where
      0 indicates that the consumption of the analytics ID had no significant effect in the expected network status pattern
      1 indicates that the consumption of the analytics ID had significant positive effect in the expected network status pattern (e.g., improved the pattern of the KPIs)
      −1 indicates that the consumption of the analytics ID had significant negative effect in the expected network status pattern (e.g., degraded the pattern of the KPIs)

Unstable Analytics ID Information (UAidI): one or more information that identifies the grade associated with a consumed analytics (ID and/or outputs) crossing, deviating thresholds that denote an analytics has been identified as leading to unstable network status. Examples of information including the UAidI are any of the following:
Identification of UAidI
Identification of Analytics ID type: the type analytics ID for which a grade has to be calculated
(List of) Identification of analytics ID output: identification of the one or more analytics output information for the analytics ID that were consumed in the interval of time for the grade calculation
Calculated grade
Grade value deviation from thresholds

NF Feedback: the information that qualifies the consumption of an analytics (ID and/or output(s)) in the perspective of the consumer of such analytics. Examples of the NF feedback information can be any of the following:
NF Feedback can be a set of information equivalent to the Analytics ID Grade Information (AidGI), where the NF (e.g., Analytics Consumer) based on its internal information defines a grade for the consumed analytics (ID and/or output(s))
NF Feedback can be a set of information equivalent to the Unstable Analytics ID Information (UAidI), where the NF (e.g., Analytics Consumer) based on its internal information identifies grades for the consumed analytics (ID and/or output(s)) and thresholds being crossed indicating problems with the analytics.
NF Feedback can be a tuple with the information about the analytics (ID and/or output(s)) and a flag indicating problems with the analytics.

Analytics Tracing Data Structure (ATDS): one or more network states for an analytics (e.g., analytics ID, analytics type, analytics output(s)). ATDS is a historical set of ADTS records that have the association of an analytics ID to analytics output(s), an indication of the quality of usage of the analytics in the mobile network, and the configuration at inference and/or training for the analytics (which can mean analytics output(s) or analytics IDs or analytics types), and optionally the analytics rollback actions and/or rollback status. With this data structure it is possible to traces over time for an analytics ID, the different association of analytics output(s) of this analytics ID, analytics ID grade values (AidGI) and/or UAidI alerts and/or NF feedbacks, the information of the inference and/or training configurations (e.g., AICI and/or ATCI) for the analytics output(s) or analytics IDs, and optionally the rollback status if an analytics rollback has been performed and associated with a ATDS record. The analytics ID grade values (AidGI) and/or UAidI alerts are examples of indication of the quality of usage the analytics ID in the mobile network.

Analytics ID Inference Configuration Information (AICI): one or more information related to configuration and/or parametrization of used by an Inference NF for generating an analytics (ID and/or output). An AICI includes any of the examples of information listed below:
Configurations are: interval of data collection for generating the analytics; whether pre-processing of collected data for analytics generation has been applied; type of collected data for generating the analytics; mappings of Access Network properties (such as TAs, Cells, Radio Type, Radio Frequency) to Core Network entities (e.g., associated TAs to AMFs) or properties (e.g., restricted or unrestricted S-NSSAIs per TAs); geographical aggregation level (e.g., per UEs, per AoI), temporal aggregation (i.e., per minute, per hour).
Parametrization are related to the Analytics Filter Information and Analytics Reporting Information (as defined in 3GPP TS 23.288 Release 17) for the generation of an analytics, or related to the Data Specification or Format and Processing (as defined in 3GPP TS 23.288 Release 17) definitions when collecting the data for the generation of an analytics

Analytics ID Training Configuration Information (ATCI): One or more Information related to configuration and/or parametrization for a Machine Learning (ML) Model or simply Model (e.g., optimization model) used by for an analytics (ID and/or output(s)) in a given point in time. An ATCI includes any of the examples of information listed below:
Configurations are: interval of data collection for training the ML model or model for the analytics; whether pre-processing of collected data for analytics training has been applied; type of collected data for training the analytics; mappings of Access Network properties (such as TAs, Cells, Radio Type, Radio Frequency) to Core Network entities (e.g., associated TAs to AMFs) or properties (e.g., restricted or unrestricted S-NSSAIs per TAs), geographical aggregation level (e.g., per UEs, per AoI), temporal aggregation (i.e., per minute, per hour).
Parametrization related to the requested analytics ID to be trained or modeled: Analytics Filter Information and Analytics Reporting Information (as defined in 3GPP TS 23.288 Release 17) for the analytics, or related to the Data Specification or Format and Processing (as defined in 3GPP TS 23.288 Release 17) definitions when collecting the data for the analytics training or statistics calculation
Parametrization related to the ML model or model: type of algorithm; gradients; weights; architecture information about the model (e.g., if neural networks the number of layers, the amount of neurons per layer), type of activation functions, type of loss functions, number of epochs used for training, configuration of the model validation (e.g., 5-crossfold validation), distribution of the amount of data for the different phases (training, validation testing), score for all phases training, validation, and test; type of used metrics (e.g., median absolute error, mean square error, coefficient of determination R\hat{ }2, F1-Score, Accuracy, Recall, Precision, etc.).

Inference Rollback Notification (IRN): one or more information, possibly enclosed in a message, defining the rollback actions related to an existing analytics ID that can be enforced by an Inference NF. The Inference Rollback Notification, can be for instance:
a message containing the one ATDS record with the unstable analytics ID information and another ATDS record with the ATDS record associated with the last known stable network state for the analytics ID.
Another possible embodiment for an Inference Rollback Notification is to have parameter such as tuple with the identification of analytics ID and/or analytics output and a flag, where this flag denotes that there is a problem (or an error) with the analytics (ID and/or output(s)). Examples of flags that can be used are any of the following: unstable analytics, halt analytics usage, invalid analytics, temporary invalid analytics, and trigger inference rollback.

Training Rollback Notification (TRN): one or more information, possibly enclosed in a message, related the rollback actions related to an existing analytics (ID and/or output(s)) that can be enforced by a Training NF. The Training Rollback Notification can be for instance:
A message containing the training information (e.g., ATCI) of an ATDS record with the ML model configuration or parametrization for the unstable analytics ID and another training information (ATCI) of the ATDS record with ATDS record associated with the last known stable network state for a ML model for the analytics ID.
Another possible embodiment for a Training Rollback Notification is to have parameter such as tuple with the identification of analytics ID and/or analytics output and a flag, where this flag denotes that there is a problem (or an error) with the analytics (ID and/or output(s)).

Examples of flags that can be used are any of the following: unstable analytics, halt analytics usage, invalid analytics, temporary invalid analytics, and trigger training rollback.

Unstable Analytics Notification (UN): one or more information that identifies an analytics ID and/or analytics output(s) as Unstable Analytics ID, i.e., an analytics (ID and/or output(s)) that are related to problems in the network status. The Unstable Analytics Notification includes any of the information listed as examples below:
The ATDS record with the Analytics Inference Configuration Information (AICI) and/or Analytics Training Configuration Information (ATCI) for the analytics ID of the ATDS record that has been considered as Unstable Analytics ID. This information will indicate that there is a problem (and/or an error) with the analytics ID and/or analytics outputs.
A parameter such as tuple with the identification of analytics ID and/or analytics output and a flag, where this flag denotes that there is a problem (or an error) with the analytics (ID and/or output(s)). Examples of flags that can be used are: unstable analytics, halt analytics usage, invalid analytics, and temporary invalid analytics.

Indication for re-selection: one or more information that relates an ML model and/or model to an analytics ID and/or analytics output(s) that is considered Unstable Analytics ID, i.e., an analytics (ID and/or output(s)) that are related to problems in the network status.

An indication for re-training: Is one or more information that relates the need (e.g., request) for ML model and/or model training (and/or retraining) to an analytics ID and/or analytics output(s) that is considered Unstable Analytics ID, i.e., an analytics (ID and/or output(s)) that are related to problems in the network status.

Training Rollback Information: Is the one or more information that indicates a change in the ML model and/or model related to an analytics ID and/or analytics output(s), where the ML model and/or model has been identified as associated with an Unstable Analytics ID, i.e., an analytics (ID and/or output(s)) that are related to problems in the network status. Examples of the one or more information including the training rollback information are:
Identification of ML model and/or model related to an Unstable Analytics ID
Description of the changed information related to the ML model and/or model related to an Unstable Analytics ID
One or more changed information related to the ML model and/or model related to an Unstable Analytics ID (e.g., gradients, version, architecture)
ML model and/or model script and/or file and/or configuration with the changes

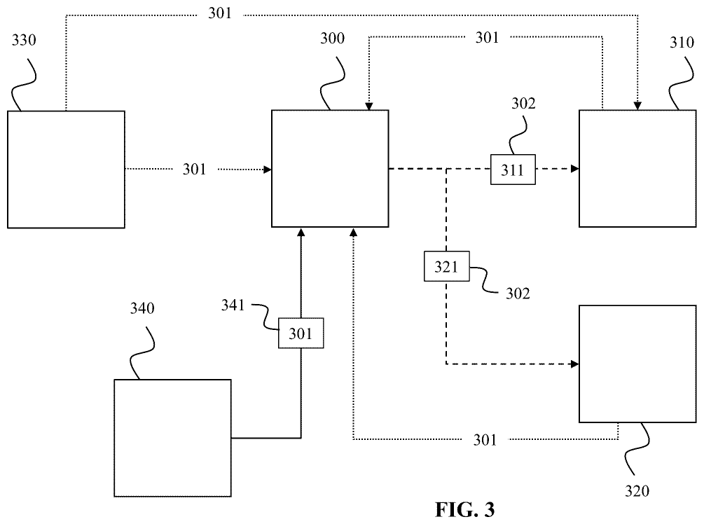

FIG. 3 shows various entities 300, 310, 320, 330, 340 according to embodiments, where the entities participate in one way or the other in the procedure. FIG. 3 shows a network analytics tracing entity 300 (also referred to as “analytics tracing NF”), a network analytics inference entity 310 (e.g., NWDAF inference, also referred to as “inference NF”), a network analytics training entity 320 (e.g., NWDAF training, also referred to as “training NF”), a network analytics consumer entity 330 (e.g., NWDAF consumer, also referred to as “consumer” or “consumer NF”), and a network analytics management entity 340.

Each entity 300, 310, 320, 330, 340 may comprise a processor or processing circuitry (not shown) configured to perform, conduct, or initiate the various operations of the respective entity 300, 310, 320, 330, 340 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. Each entity 300, 310, 320, 330, 340 may further comprise memory circuitry, which stores one or more instruction(s) that can be executed by the processor or by the processing circuitry, such as under control of the software. For instance, the memory circuitry may comprise a non-transitory storage medium storing executable software code which, when executed by the processor or the processing circuitry, causes the various operations of the respective entity 300, 310, 320, 330, 340 to be performed. In one embodiment, the processing circuitry includes one or more processors and a non-transitory memory connected to the one or more processors. The non-transitory memory may carry executable program code which, when executed by the one or more processors, causes the respective entity 300, 310, 320, 330, 340 to perform, conduct or initiate the operations or methods described herein.

The respective entities 300, 310, 320, 330, 340, may be part of the same mobile network, for example, of a 5G mobile network. The entities 300, 310, 320, 330, 340 may be further configured to interact with each other, via the mobile network they are part of. The entities 300, 310, 320, 330, 340 may be configured to communicate with each other, i.e., to exchange information by providing information to another entity and/or receiving information from another entity. Any communication between two of the entities 300, 310, 320, 330, 340 may involve further entities (also not-described entities) in the mobile network, i.e., communications may be direct or indirect.

The network analytics tracing entity 300 is configured to obtain an indication 301 with information to activate a tracing of one or more analytics outputs for an analytics ID and/or a tracing of the analytics ID. For instance, it may receive the indication 301 from the consumer entity 330, from the inference entity 310 (which may receive it from the consumer entity 330), or from the training entity 320. Further, the tracing entity 300 may also be configured with the indication 301, in order to obtain it, for example, by the management entity 340 via a configuration 341.

The tracing entity 300 is further configured to provide a rollback notification 302 related to the analytics ID, if at least one output for the analytics ID is unstable and/or if the analytics ID is unstable. The rollback notification 302 may comprise the at least one unstable analytics output for the analytics ID and/or the analytics ID, and may be provided to the consumer entity 330, the inference entity 320, or the training entity 320. Further, it may comprise an inference rollback action 311 for the at least one unstable analytics output for the analytics ID and/or for the analytics ID, where in this case the rollback notification 302 is provided to the network analytics inference entity 310. It may also comprise a training rollback action 321 for the at least one unstable analytics output for the analytics ID and/or for the analytics ID, where in this case the rollback notification 302 is provided to the network analytics training entity 320.

The network analytics inference entity 310 is configured to obtain an inference rollback action 311 for at least one analytics output for an analytics ID and/or for the analytics ID. For instance, it may obtain the inference rollback action 311 by receiving the rollback notification 302 related to the analytics ID from the network analytics tracing entity 300. It may extract the inference rollback action 311 from the rollback notification 302 or may determine it based on the rollback notification 302. Another possibility is that the inference entity 310 is configured with the inference rollback action 311, for instance, by the tracing entity 300 or the management entity 340.

Further, the inference entity 310 is configured to execute the inference rollback action 311, where executing the inference rollback action 311 includes at least one of: changing an inference configuration about the at least one analytics output for the analytics ID and/or about the analytics ID; determining and setting a new inference configuration about the at least one output for the analytics ID and/or about the analytics ID; selecting a new analytics model for the at least one analytics output for the analytics ID and/or for the analytics ID; and deactivating an analytics model for the at least one analytics output for the analytics ID and/or for the analytics ID. The rollback notification 302 may indicate which of the above to perform.

The network analytics training entity 320 is configured to obtain a training rollback action 321 for at least one analytics output for an analytics ID and/or for the analytics ID. For instance, it may obtain the training rollback action 321 by receiving the rollback notification 302 related to the analytics ID from the network analytics tracing entity 300. It may extract the training rollback action 321 from the rollback notification 302 or may determine it based on the rollback notification 302. Another possibility is that the training entity 320 is configured with the training rollback action 321, for instance, by the tracing entity 300 or the management entity 340.

Further, the training entity 320 is configured to execute the training rollback action 321, where executing the training rollback action 321 includes at least one of: changing a training configuration about the at least one analytics output for the analytics ID and/or about the analytics ID; selecting and setting a new training configuration about the at least one analytics output for the analytics ID and/or about the analytics ID; performing a retraining or a reselection of an analytics model for the at least one analytics output for the analytics ID and/or for the analytics ID; deactivating an analytics model for the at least one analytics output for the analytics ID and/or for the analytics ID. The rollback notification 302 may indicate which of the above to perform.

The network data analytics consumer entity 330 is configured to provide the indication 301 with the information to activate a tracing of one or more analytics outputs for an analytics ID and/or a tracing of the analytics ID to either the network analytics tracing entity 300 or the network analytics inference entity 310.

The network analytics management entity 340 may be configured to perform a configuration 341 to activate a tracing of one or more analytics outputs for an analytics ID and/or a tracing of the analytics ID, for instance, at the tracing entity 300. Further, the management entity 340 may be configured to configure analytics tracing information 403 for the analytics ID, for instance, at the tracing entity 300. Further, the management entity 340 may be configured to perform a configuration 341 to activate a collection of data for one or more quality indications about the one or more analytics outputs for the analytics ID and/or about the analytics ID, for instance, at the tracing entity 300 or at the consumer entity 330.

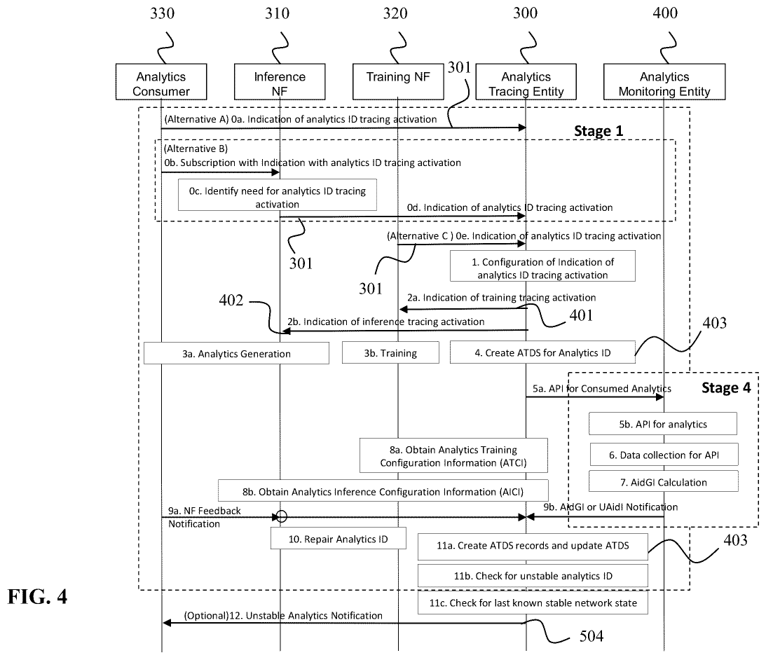

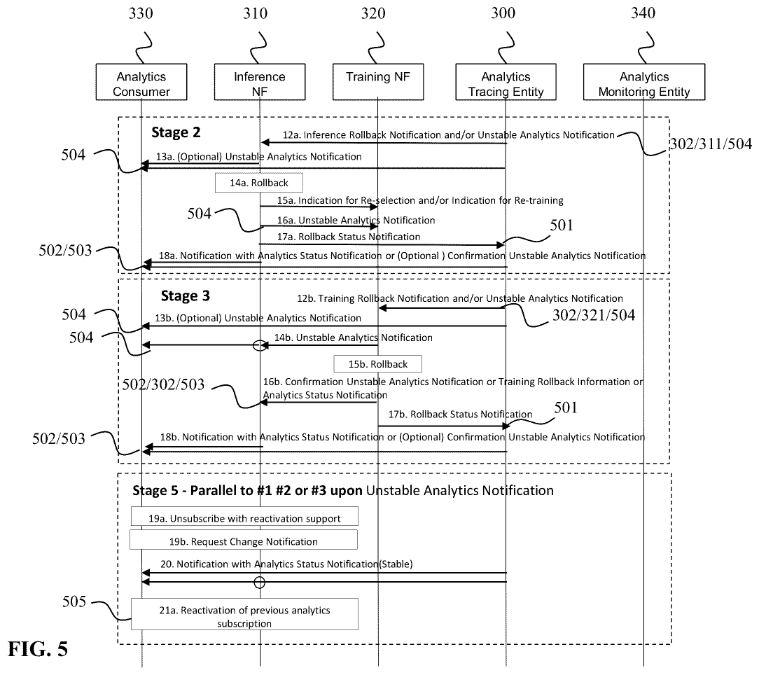

FIG. 4 and FIG. 5 show an exemplary, detailed procedure as a solution to the problems mentioned in the summary part. The procedure involves various entities 310, 320, 330 according to the embodiments, for instance, as already described with respect to FIG. 3. The proposed solution is composed of at least one of five stages. FIG. 4 shows the stages 1 and 4, while FIG. 5 shows the stages 2, 3, and 5. Thereby:
Stage 1 includes tracing of analytics information, determining unstable analytics (outputs and/or IDs), and triggering analytics rollback actions 311, 321.
Stage 2 includes handling analytics (inference) rollback actions 311, 321 at the network analytics inference entity 310.
Stage 3 includes handling analytics (training) rollback actions 311, 321 at the network analytics training entity 320.
Stage 4 includes analytics consumption association to network status.
Stage 5 includes analytics consumer entity 330 actions upon unstable analytics notification.
   Stage 1 and Stage 4 are mandatory in this exemplary procedure shown in FIG. 4 and FIG. 5. The Stages 2 and 3 comprise alternatives of actions that can be taken optionally into the solution upon Stage 1. Stage 5 is optional and can be activated upon the Stages 1, 2, 3.

As shown in FIG. 4, in Stage 1, the new entity called the network analytics tracing entity 300 obtains (Step 0, 1) the analytics ID tracing activation, e.g., by receiving the indication 301 (notably, a synonym of analytics ID is analytics type or simply analytics). Based on this obtained analytics ID tracing activation, the tracing entity 300 creates (Step 4) analytics tracing information 403 (i.e., an ATDS) associated with the analytics ID, e.g., an ATDS for an analytics ID, or an ATDS of an analytics ID. The created ATDS may maintain and store a set of ATDS records over time. Therefore, ATDS is in this case may be a historical set of ATDS records that have the association of an analytics ID to analytics output(s), an indication of the quality of usage of the analytics (ID and/or output(s)) in the mobile network, the configuration at inference and/or training for the analytics (which can mean analytics output(s) or analytics IDs or analytics types), and optionally the analytics rollback actions and/or rollback status. Each ATDS record may define the network status when using an analytics ID in the mobile networks and may comprise a tuple that has the mapping in a given point in time of an analytics ID to at least one of the following parameters:
Timestamp of record creation.
One or more analytics output identifications and/or one or more analytics output.
An indication of the quality of usage of the analytics (ID and/or output(s)) in the mobile network including: Analytics ID Grade Information (AidGI) and/or Unstable Analytics ID Information (UAiDI) for analytics output instance(s) from an analytics monitoring entity 400 (e.g., an NWDAF or another NF) or a NF feedback from a NF or consumer entity 330.
AICI) from an inference entity 310 (e.g., Inference NF, NWDAF containing Analytics logical function (AnLF)) and/or ATCI from a training entity 320 (e.g., Training NF, or NWDAF containing Model Training logical function (MTLF)) for the analytics (which can mean analytics output(s) or analytics IDs or analytics types).
(Optionally) analytics rollback actions 311, 321.
(Optionally) Rollback status (or Rollback Status Notification), is the set of information describing the results of performing Analytics Rollback Actions 311, 321.

The analytics ID tracing activation (e.g., the creation of an ATDS associated with the analytics ID) can be obtained by the tracing entity 300 based on at least one of:
A NF (e.g., a NWDAF Consumer or consumer entity 330 such as NFs, or NWDAF containing Analytics logical function (AnLF), or NWDAF containing Model Training logical function (MTLF)) providing an indication 301 for analytics ID tracing activation to the tracing entity 300 (Steps 0a-e);
A management entity 340 (e.g., OAM) providing to the tracing entity 300 a configuration of the analytics ID tracing activation (Step 1).

Depending on how the analytics ID tracing activation has been obtained by the tracing entity 300, it is possible that the tracing entity 300 has to provide to the inference entity 310 and/or to the training entity 320, respectively, an indication of inference tracing activation 402 and/or an indication of training tracing activation 401. For instance:
If the tracing entity 300 received the indication 301 for the analytics ID tracing activation from the consumer entity 330 (Step 0a) or is configured to activate the tracing (Step 1), then the tracing entity 300 needs to indicate to the inference entity 310 and/or the training entity 320 that the tracing and rollback processes related to an analytics (ID and/or output(s)) will be performed. The inference entity 310 and/or the training entity 320 are then triggered by an indication of the inference tracing activation 402 or an indication of training tracing activation 401 to perform the tracing, and if required analytics rollback actions 311, 321 as will be described below.
If the tracing entity 300 received the indication for analytics ID tracing activation from the inference entity 310 (step Od), then the tracing entity 300 optionally needs to indicate to the training entity 320 that the tracing and rollback processes related to an analytics (ID and/or output(s)) will be performed.
If the tracing entity 300 received the indication for analytics ID tracing activation from the training entity 320 (Step 0e), then the tracing entity 300 optionally needs to indicate to the inference entity 310 that tracing and rollback processes related to an analytics (ID and/or output(s)) will be performed.

The tracing entity 300 regularly obtains the information to create, compose, and assemble an ATDS record (Steps 5-9), which may include at least one of:
Analytics output generation (e.g., the analytics output identification or the analytics output itself).
The Analytics ID Grade Information (AidGI) and/or Unstable Analytics ID Information (UAiDI) and/or NF Feedback about analytics output.
AICI and/or ATCI for the analytics output(s) and/or analytics IDs.

The tracing entity 300 based on the regularly obtained information to create, compose, assemble an ATDS record, creates an ATDS record and includes, adds, and stores this ATDS record in the ATDS for the analytics ID (Step 11a).

The tracing entity 300 regularly checks the ATDS of the analytics IDs in order to determine if there is an unstable analytics associated with the analytics ID (Step 11b). When the tracing entity 300 identifies the ATDS record with an unstable analytics ID, it inserts this information (e.g., as a flag) in the ADTS record. For the determination, identification of an unstable analytics in an ATDS record, the tracing entity 300 can perform any of the following processes:
Identify that an ATDS record of the ATDS for an analytics ID contains a feedback from an NF (e.g., NF feedback) with the indication of problems being caused by one or more analytics outputs for the analytics ID.
Perform the determination of an unstable analytics. There are different ways in which the tracing entity 300 may perform the determination of an unstable analytics.
   One possible way is by verifying that the ATDS record has the unstable analytics ID Information (UAiDI), which indicates that an analytics ID is leading to an unstable network status.
   Another possible alternative is when the tracing entity 300 checks a subset of the ATDS records for an analytics ID and identifies that the grade information associated with the Analytics ID Grade Information (AidGI) is following a trend that indicates a deterioration of the network status, potentially leading to an unstable network status. For instance, an example of a check is the tracing entity 300 applying a moving average in the grades of the last ten ATDS records and based on this check it detects a tendency on the reduction of the grades.

When the tracing entity 300 identifies an unstable analytics (e.g., the existence of an ATDS record associated with a considered unstable analytics ID), it checks other ATDS record for the analytics ID (that do not have the information of unstable analytics ID) in order to determine the last known stable network state for the analytics (Step 11c). The last known stable network state for the analytics is the ATDS record with the most appropriated Analytics Inference Configuration Information (AICI) and/or Analytics Training Configuration Information (ATCI) for analytics output(s) and/or an analytics ID. There are different possible alternatives to determine the last known stable network state for the analytics.
The tracing entity 300 selects an ATDS record from the ATDS for the analytics that has the best analytics grade value stored, recorded in Analytics ID Grade Information (AidGI).
The tracing entity 300 selects an ATDS record that has the most often used AICI and/or ATCI for an analytics ID.
The tracing entity 300 calculates the average for the grade values stored, recorded in Analytics ID Grade Information (AidGI) of the ATDS records for an analytics ID, and identify the most often used AICI and/or ATCI for analytics output(s) and/or an analytics ID that is within a standard deviation from the calculated average for the grade values.

When the tracing entity 300 identifies the last known stable network state for the analytics (i.e., identifies the ATDS record with the most appropriated AICI and/or ATCI for an analytics ID) the tracing entity 300 determines if analytics rollback actions 311, 312 should be triggered, e.g., reverting, changing the configurations, parameters, related to an analytics ID being used by the consumer entity 330 and/or inference entity 310 and/or training entity 320. Examples of the identification of the need for analytics rollback actions 311, 321, as well as the identified analytics rollback actions 311, 321 (also called only “rollback actions”) are described as follows:
Option 1: If the AICI and/or ATCI for the analytics ID of the ATDS record associated with the unstable analytics is the same as the AICI and/or ATCI for the analytics ID of the ATDS record identified as last known stable network state for the analytics, then the tracing entity 300 cannot perform a rollback, because there is not an alternative AICI and/or ATCI for the analytics ID to be used. In this case, the tracing entity 300 can provide an Unstable Analytics Notification 504 to the consumer entity 330 (Step 13a in Stage 2) and/or the inference entity 310 (Step 12a in Stage 2) and/or the training entity 320 (Step 12b in Stage 3). In this case it is up to the entity receiving such Unstable Analytics Notification 504 to decide if something can be done to solve the problem.
If the AICI) and/or ATCI for the analytics ID of the ATDS record associated with the unstable analytics is different than the AICI and/or ATCI for the analytics ID of the ATDS record identified as last known stable network state for the analytics, then the tracing entity 300 can decide to perform the following actions:
Option 2: If the AICI is the different information between the two compared ATDS records, provide an Inference Rollback Notification 302 (may include rollback action 311) to the inference entity 310 (Step 12a in Stage 2) containing the AICI associated with the unstable analytics ID and/or AICI associated with the last known stable network state for the analytics. This action will trigger the Stage 2 in the proposed solution.
Option 3: If the ATCI is the different information between the two compared ATDS records, provide the Training Rollback Notification 302 (may include rollback action 321) to the training entity 320 (Step 12b) containing the ATCI associated with the unstable analytics ID and/or ATCI associated with the last known stable network state for the analytics. This action will trigger the Stage 3 in the proposed solution.
Option 4: If both AICI and ATCI are different information between the two compared ATDS records, provide an Inference Rollback Notification 302/311 to the inference entity 310 (Step 12a in Stage 2) containing the AICI and ATCI associated with the unstable analytics ID and/or AICI and ATCI associated with the last known stable network state for the analytics. This action will trigger the Stage 2 in the proposed solution.
Option 5: If both AICI and ATCI are different information between the two compared ATDS records, the tracing entity 300 can trigger simultaneously the Stage 2 and Stage 3 of the solution. When the tracing entity 300 triggers the Stage 2, it provides an Inference Rollback Notification 302/311 to the inference entity 310 (Step 12a in Stage 2) containing the AICI associated with the unstable analytics ID and/or AICI associated with the last known stable network state for the analytics. When the tracing entity 300 triggers the Stage 3, it provides the Training Rollback Notification 302/321 to the training entity 320 (Step 12b) containing the ATCI associated with the unstable analytics ID and/or ATCI associated with the last known stable network state for the analytics.

As shown in FIG. 5 in Stage 2, when the inference entity 310 obtains the analytics rollback actions 311, the inference entity 310 verifies the information including the analytics rollback actions 311:
If the information denotes an Unstable Analytics Notification 504, the inference entity 310 can perform the following actions:
   Provide the Unstable Analytics Notification 504 to the consumer entity 330 (Step 13a) of the analytics (ID and/or output(s)) indicated in the Unstable Analytics Notification 504. For instance, the inference entity 310 could forward the exact same Unstable Analytics Notification 504 to the consumer entity 330, or the inference entity 310 may process the information from the obtained Unstable Analytics Notification 504 and generate another Unstable Analytics Notification 504 to the sent to the consumer entity or entities 330. Examples of processing are: removing information about AICI or ATCI from the Unstable Analytics Notification 504, and transforming this message into a tuple of analytics (ID and/or output(s)) and a flag indicating the unstable analytics ID.
If the information denotes an Inference Rollback Notification 302, the inference entity 310 can perform the following actions:
   (Optionally) Provide and/or forward the Unstable Analytics Notification 504 to the consumer entities 330 (Step 13a), following the same processing described when the information associated with the rollback actions 311 denotes an Unstable Analytics Notification 504. Additionally, if processing of the Unstable Analytics Notification 504 is performed by the inference entity 310, the processed Unstable Analytics Notification 504 can also contain further information such as a timer indicating the interval of time estimated for the rollback actions 311 to be performed. This will allow the consumer entity 330 to understand that after this period of time either it will receive from the inference entity 310 (and/or tracing entity 300) a confirmation of a change in the analytics status (e.g., from unstable analytics ID to stable analytics ID when rollback is successful, a confirmation of unstable analytics ID).
   Analyze the obtained information and enforce changes in the analytics (id and/or output(s)) related to the analytics rollback actions 311 (Step 14a). The following actions can be performed according with the obtained information:
      (Option 2.1/5.1) If the analytics rollback actions 311 includes two sets of information both related to the AICI, one set of information is related to the current AICI associated with an analytics (ID and/or output(s)) and the second set of information is related to the new possible AICI, then inference entity 310 will exchange the old with the new set of AICI.
      (Option 2.2/5.2) If the analytics rollback actions 311 includes one set of information related to the AICI, the one set of information is related to the current AICI associated with an analytics (ID and/or output(s)) considered unstable analytics ID, then the inference entity 310 can determine the new AICI and use this information for the generation of the analytics (ID and/or output(s))
      (Option 2.3/5.3) If the analytics rollback actions 311 includes one set of information related to the AICI, the one set of information is related to the new AICI associated with an analytics (ID and/or output(s)) considered stable analytics ID, then the inference entity 310 can exchange its local current configuration for the analytics with the new AICI and use this information for the generation of the analytics (ID and/or output(s))
      (Option 4.1) If the analytics rollback actions 311 includes four sets of information being two sets of information related to the current AICI and ATCI associated with an analytics (ID and/or output(s)) and the other two sets of information related to the new AICI and ATCI associated with an analytics (ID and/or output(s)), then the inference entity 310 can:
         Decide to exchange only the old with the new set of AICI and use it for analytics generation.
         Decide to exchange the old with the new set of AICI and the old with the new set of ATCI and use them for analytics generation. In this case, if the inference entity 310 does not have the ML model and/or model indicated in the ATCI, the inference entity 310 may discover and request from a training entity 320 the indicated ML model and/or model related to the ATCI (i.e., may perform model reselection).
         Decide to exchange only the old with the new set of ATCI and use it for analytics generation, once again the inference entity 310 may need to perform model reselection if the ML model and/or model in new ATCI is not available at the inference entity 310.
      (Option 4.2) If the analytics rollback actions 311 includes two sets of information being the two sets of information related to the current AICI and ATCI associated with an analytics (ID and/or output(s)), then the inference entity 310 can:
         Decide to determine only the new set of AICI and use it for analytics generation;
         Decide to determine (e.g., reselect) a new ML model and/or model for the analytics generation without informing any training entity 320 of the reason for the reselection;
         Decide to determine (e.g., reselect or request retraining) a new ML model and/or model to be used for the analytics generation and provide an indication for re-selection and/or an indication for re-training to the training entity 320 (Step 15a FIG. 4);
         Decide to inform the training entity 320 about the problem in the analytics (ID and/or output(s)) (Step 16a FIG. 4), in this case the inference entity 310 can send an Unstable Analytics Notification 504 to the training entity 320.

When the inference entity 310 finishes executing analytics rollback actions 311, it can provide any of the following information:
the Rollback Status Notification 501 to the tracing entity 300 (Step 17a);
the Analytics Status Notification 502 (e.g., in case of successful enforcement of analytics rollback actions 311) to the consumer entity 330 (Step 18a)
Confirmation of Unstable Analytics Notification 503 (e.g., in case of unsuccessful enforcement of analytics rollback actions 311) to the consumer entity 330 (Step 18a)

As shown in FIG. 5, in Stage 3, when the training entity 320 obtains the analytics rollback actions 321, the training entity 320 verifies the information including the analytics rollback actions 321 (Step 15b):
If the information denotes an Unstable Analytics Notification 504, the training entity 320 can perform the following actions:
   Provide and/or Forward the Unstable Analytics Notification 504 to any other training entity 320 related in the training or model tuning process of the ML model and/or model associated with the analytics (ID and/or output(s)) indicated in the Unstable Analytics Notification 504. This will allow all the training entity 320 involved in the process of training or model tuning process of the ML model and/or model associated with the analytics to become aware of problems. When the (first) training entity 320 provides the Unstable Analytics Notification 504 to other training entities 320, the (first) training entity 320 may apply some further processing in the received Unstable Analytics Notification 504 before sending it to the other training entities 320. For instance, it can include information related to the shared training such as partial ML model and/or model weights, parameters received in a federated training.
   Provide and/or Forward the Unstable Analytics Notification 504 to the inference entity 310 (or entities) that consumed the ML model and/or model related in the Unstable Analytics Notification 504 (Step 14b FIG. 4). For example, the analytics ID and/or output(s) identification is included in the Unstable Analytics Notification and the training entity 320 identifies the list of inference entities 310 that requested or subscribed or were provided with the ML model and/or model associated with such analytics.
If the information denotes a Training Rollback Notification 302, the training entity 320 can perform the following actions:
   (Option 3.1/5.1) If the analytics rollback actions 321 includes two sets of information both related to the ATCI, one set of information is related to the current (also referred as old) ATCI associated with an analytics (ID and/or output(s)) and the second set of information is related to the new possible ATCI, then the training entity 320 can exchange the old with the new set of ATCI. The training entity 320 can optionally perform the following actions:
      Identify all the consumers of the ML model and/or model associated with the current ATCI and provide the ML model and/or model associated with the new ATCI to these entities. This can include, pushing or notifying, or sending the updated ML model and/or model the inference entity 310 that consumed such model or to other training entities 320 that shared during the training phase the changed ML model and/or model including also the reason why the change is required, showing that the current (before change) ML model and/or model being used by the consumers is related to an Unstable Analytics ID. Including this reason will enable the consumer of the ML model and/or model to understand that this is a required change to bring the generation of analytics IDs to a stable state and not just an optimization.
      (optionally) Mark the ML model and/or model associated with the analytics (ID and/or output(s)) of the old obtained ATCI as deactivated.
   (Option 3.2/5.2) If the analytics rollback actions 321 includes one set of information related to the ATCI, the one set of information is related to the current ATCI associated with an analytics (ID and/or output(s)) considered unstable analytics ID, then training entity 320 can perform any of the following:
      determine the new ATCI for the ML model and/or model for the analytics (ID and/or output(s)) related to the current ATCI via training and/or model tuning; and optionally once again identify all the consumers of the ML model and/or model associated with the new ATCI and provide the Training Rollback Information 302, with the new updated ML model and/or model to these entities (as described above).
      (optionally) Mark the ML model and/or model associated with the analytics (ID and/or output(s)) of the old obtained ATCI as deactivated.
   (Option 3.3/5.3) If the analytics rollback actions 321 includes one set of information related to the ATCI, the one set of information is related to the new ATCI associated with an analytics (ID and/or output(s)) considered stable analytics ID, then the training entity 320 can exchange its local current configuration for the analytics with the new ATCI for ML model and/or model for the analytics (ID and/or output(s)); and optionally once again identify all the consumers of the ML model and/or model that has been modified and provide the Training Rollback Information 302, with the new updated ML model and/or model to these entities (as described above).
   It is possible that for determining a new ATCI for the ML model and/or model for the analytics (ID and/or output(s)) the training entity 320 needs to interact with other training entities 320, if the ML model and/or model requires shared training. In this case, the training entity 320 may identify the required further training entities 320 and sends any of the following information that will trigger the training entities 320 to collaborate among each other to determine the new ML model and/or model for the analytics:
      an indication of the reason for re-selection related to an unstable analytics ID
      an indication of the reason for re-training related to an unstable analytics ID
   It is also possible that the training entity 320 cannot determine a new ATCI or change the current ATCI for a new ATCI for the ML model and/or model for the analytics (ID and/or output(s)) associated with the obtained analytics rollback actions 321. In this case the training entity 320 can provide to the inference entity 310 a confirmation of Unstable Analytics Notification 504, if it previously provided an Unstable Analytics Notification 504 (Step 16b), or it can provide an Unstable Analytics Notification 504 to the inference entity 310 that is a consumer of the ML model and/or model related to the ATCI.

When the training entity 320 finishes executing analytics rollback actions 321, it can provide any of the following:
The Confirmation of Unstable Analytics Notification 503 or Training Rollback Information 302 or Analytics Status Notification 504 to the inference entity 310 (Step 16b)
The Rollback Status Notification 501 to the tracing entity 300 (Step 17b).

If the inference entity 310 received from training entity 320 an Unstable Analytics Notification 504 (Step 14b FIG. 4) and forwarded such information to the consumer entity 330, when the inference entity 310 receives from the training entity 320 a Confirmation of Unstable Analytics Notification 503 or Training Rollback Information 302 or Analytics Status Notification 502, the inference entity 310 optionally can provide or forward to the consumer entity 330 the Analytics Status Notification 502 or the Confirmation Unstable Analytics Notification 503 (Step 18b FIG. 4).

As shown in FIG. 4, in stage 4, a new entity called network analytics monitoring entity 400 (AMon Entity) that obtains the (Step 5a or 5b) Analytics Performance Information (API) for a consumed analytics (ID and/or output(s)) optionally for a consumer of the analytics from other Entity (e.g., tracing entity 300, consumer entity 330). The goal of the API is to capture KPIs and/or metrics that are not relevant as input data for the generation of an analytics (ID and/or output(s)), but that are relevant for the identification of how a consumed analytics changes the network status.

Based on the API, the monitoring entity 400 identifies the sources of data collection for the KPIs and/or metrics related to the API and starts the data collection from these data sources.

The API can be obtained using any of the following possibilities:
A configuration 341 from a network analytics management entity 340;
A combination of configuration 341 from a management entity 340 and receiving a message from another entity including the analytics (ID and/or output(s)) and/or analytics consumer entity 330 that should be associated with the configured API
A message received from other entity (e.g., tracing entity 300, training entity 320, inference entity 310) including the API, the analytics (ID and/or output(s)) and/or consumer entity 330.

Based on the collected data related to an API, the monitoring entity 400 monitors the effects of an analytics (ID and/or output(s)) on the changes in network status after the consumption of analytics ID. This process of monitoring can result in the generation of two information:
Analytics ID Grade Information (AidGI) that is the set of information resulting from the calculation of a grade related to the effect of an analytics on the changes in network status after the consumption of analytics.
Unstable Analytics ID Information (UAiDI) that is the set of information resulting from the calculation of a grade related to the effect of an analytics on the changes in network status after the consumption of analytics and identifying that this grade as crossing, deviating from thresholds (e.g., thresholds configured by operator) that denote an analytics has been identified as leading to unstable network status.

The monitoring entity 400 provides any of the following information to other entities (e.g., the tracing entity 300):
Analytics ID Grade Information (AidGI)
Unstable Analytics ID Information (UAiDI)

In FIG. 5, Stage 5, when the consumer entity 330 (e.g., NF Consumer) receives an Unstable Analytics Notification 504 (Step 12, Step 13a, 18a, 13b, 17b), the consumer entity 330 can take different actions. For instance,
Stop the consumption of the analytics associated with the received Unstable Analytics Notification 504 by canceling or unsubscribing to the analytics at the inference entity 310. When canceling or unsubscribing, the consumer entity 330 can indicate that it would like to be notified when the analytics is again considered a Stable Analytics ID, therefore allowing the reactivation of a previous subscription to the analytics ID (Step 19a FIG. 5).
Continue the consumption of the analytics and put less weight to on the information of such analytics for its internal decision making
Continue the consumption of the analytics and request to be notified when the analytics is again considered a Stable Analytics ID (Step 19 b FIG. 5).

When the consumer entity 330 receives an Analytics Status Notification 502, the consumer entity 330 can take different actions. For instance:
If the consumer entity 330 stopped to consume an analytics, it can re-subscribe to the analytics. In this case, the consumer entity 330 indicates to the inference entity 310 that there has been a previous subscription to the analytics ID and this previous subscription, optionally for analytics IDs, should be reactivated.

In FIG. 4 and FIG. 5, common to stages 1, 2, 3, and 5, when the tracing entity 300 identifies the need for Analytics Rollback Actions 311, 321, and triggers Stage 2 and/or Stage 3, the tracing entity 330 may obtain the Rollback Status Notification 501 from the inference entity 310 (Step 17a) and/or the training entity 320 (Step 17b). The Rollback Status Notification 501 may denote the conclusion on executing the analytics rollback actions 311, 321.

When the tracing entity 300 detects the end of the analytics rollback actions 311, 321, the tracing entity 300 optionally can provide to the entity that provided the indication for analytics ID tracing activation the Analytics Status Notification 502 or a Confirmation of Unstable Analytics Notification 504. The difference between the first Unstable Analytics Notification 502 that can be provided by the tracing entity 330 (Step 12, Step 13a, 13b) and the Confirmation of Unstable Analytics Notification 503, i.e., second Unstable Analytics Notification, (Step 18a, 17b) is that the first Unstable Analytics Notification 502 indicates that a analytics rollback actions 311, 321 are being performed, while the second Unstable Analytics Notification 503 denotes that analytics rollback actions 311, 321 could successfully be performed, e.g., no rollback, reconfiguration, repair of the analytics (ID and/or output(s)) at least in a short period of time (e.g., under a minute scale, or within few minutes) could have been performed.

The benefits of this exemplary embodiment shown in FIG. 4 and FIG. 5 include:
(New) consumer entities 330, such as NFs, of one or more analytics IDs have assurances to keep consuming the analytics outputs for those analytics IDs that lead to a stable network status (even if any NF sent a Feedback indicating a problem for a previous analytics output for an analytics ID).
No interruption or break on the criteria used by entities (NFs), e.g., consumer entities 330, for the decision-making (e.g., by removing the analytics output as a criteria when NF sent feedback of problem to NWDAF, e.g., the inference entity 310).
Assurances that analytics ID usage deteriorating system KPIs (i.e., leading to unstable network status) become visible and traceable to the inference entity 310 and/or training entity 320 (e.g., NWDAFs with inference and training capability without delays caused by data collection.
Mobile operators can automatically revert the usage of unstable analytics IDs (i.e., analytics ID leading to unstable network status) while the inference entity 310 and/or training entity (e.g., one or more NWDAFs) are performing improvements or repairing the analytics IDs that are unstable or the one or more unstable analytics outputs for the analytics IDs.
No need for inspection of logs at MP, nor manual triggering of configurations in inference and training entities 310, 320, such as NWDAFs.
Allow the chains/trees of training entities 320 (e.g., NWDAFs with training capability) sharing the ML model associated with unstable analytics ID to become automatically aware of such relationship.
ML Model Designers can use this information to take decisions on next evolutions of the ML models.

Further, two possible alternatives for implementations of the proposed solution and the described entities according to the embodiments are described, all based on the entities defined in 3GPP 5G architecture in TS 23.501 R17 and enhanced Network Analytics defined in 3GPP TS 23.288 R17. The implementations are listed below.

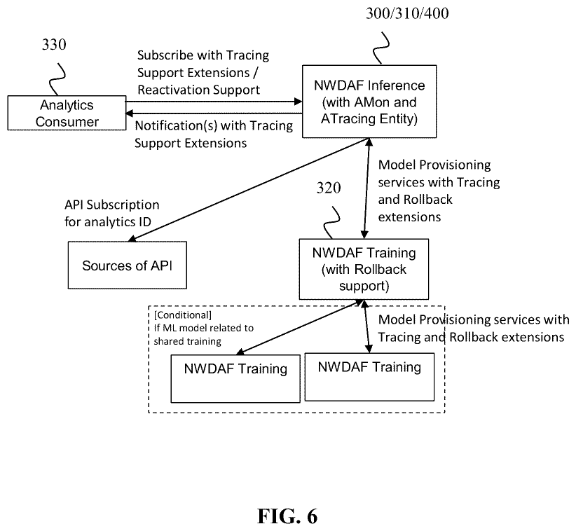

A first alternative is shown in FIG. 6 and relates to tracing and rollback support embedded in existing NWDAF services. In this first alternative, the tracing entity 300, the inference entity 310, and the monitoring entity 400 are embedded in and/or hosted by an NWDAF with inference capability (i.e., Analytics logical function (AnLF))—NWDAF(AnLF). In this case, the existing services of inference of the NWDAF (inference entity 310) are extended to support the tracing and rollback capabilities of the tracing entity 300 and monitoring entity 400. The extended services are:
Nnwdaf_AnalyticsSubscription Service
Nnwdaf_AnalyticsInfo service

Additionally, the NWDAFs with training capability (i.e., training entities 320), i.e., Model Training logical function (MTLF)—may be referred to as NWDAF(MTLF)—are enhanced to support the interactions to enable tracing and rollback actions 311, 321 when interacting with the NWDAF(AnLF) enhanced with/hosting tracing entity 300 and the monitoring entity 400. In this case also the services (e.g., training entity 320) of the NWDAF(AnLF) are enhanced to support the tracing and rollback functionalities. The enhanced services are:
Nnwdaf_MLModelProvision services

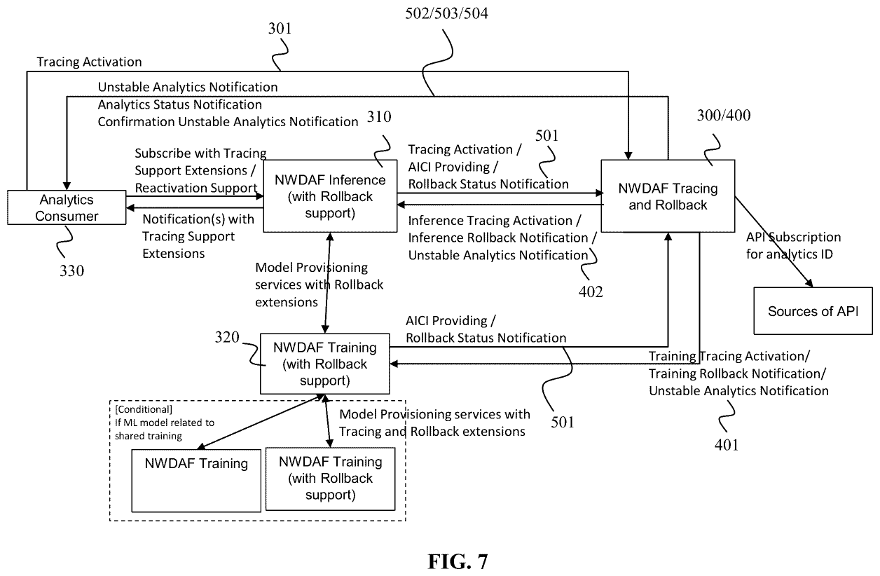

A second alternative is shown in FIG. 7 and relates to tracing and rollback support as new NWDAF services. In this second alternative illustrated in FIG. 6, the tracing entity 300 and monitoring entity 400 are embedded, hosted by an NWDAF, and dedicated new services are defined to expose the functionalities of the tracing entity 300 and monitoring entity 400 to support the tracing and rollback. The new service is defined as:
Nnwdaf_AnalyticsTracing Service

The services of an NWDAF with inference capability, NWDAF(AnLF) are also extended to support the principles. The extended services are:
Nnwdaf_AnalyticsSubscription Service
Nnwdaf_AnalyticsInfo service

The service of NWDAF with Training capability, NWDAF(MTLF), is also enhanced to support the interactions to enable tracing and rollback actions 311, 321 when interacting with the NWDAF supporting the functionalities of the tracing entity 300 and the monitoring entity 400. The enhanced service is:
Nnwdaf_MLModelProvision services

The following description provides the details of the service extensions for each of the alternatives as well as the possible procedures based on these alternatives reflecting the stages 1-5 with respect to FIG. 4 and FIG. 5.

Second alternative, where new interface is exposed by NWDAF only for analytics tracing entity 300 capabilities and analytics monitoring entity 400 capabilities:
(1) Analytics ID tracing activation: In this case, a new service needs to be defined in NWDAF in order to allow the Consumer of this service to indicate that analytics ID tracing needs to be activated in the system. The new service can be called Nnwdaf_AnalyticsTracing. An example of this new service, operations and parameters is defined as follows.
Nnwdaf_AnalyticsTracing_Subscribe:
   Input parameters:
      Identification of the consumer entity 330 of the analytics that should be traced, for instance, this identification can be the NF ID or the Notification Correlation ID of the consumer of the analytics ID (i.e., the consumer that invoked the Nnwdaf_AnalyticsSubscription_Subscribe or Nnwdaf_AnalyticsInfo_Request).
      Notification Correlation ID, which enables the consumer entity 330 of the Nnwdaf_AnalyticsTracing_Subscribe to identify its subscription to analytics tracing.
      Identification of one or more analytics ID subscriptions with associated flags with values activate/deactivate, which means that whenever the NWDAF with tracing entity 300 functionality or capability receives the invocation for Nnwdaf_AnalyticsTracing_Subscribe it will start (and/or stop depending on the value of the flag) the tracing the indicated one or more subscription to analytics ID.
      A one or more analytics ID(s) with associated flags with values activate/deactivate, which means that whenever the NWDAF with tracing entity 300 functionality or capability receives the invocation for Nnwdaf_AnalyticsTracing_Subscribe it will start (and/or stop depending on the value of the flag) the tracing the indicated one or more analytics ID.
      Additionally, information related to the API can also be included in the invocation of the Nnwdaf_AnalyticsTracing_Subscribe. Examples of such information are any of the listed below:
         One possible alternative is to reuse the fields already defined for the Nnwdaf_DataManagement service defined in Clause 7.4.2 in TS 23.288 (V17.0.0.1) in order to include those fields into the subscription/request but to define the API information. These fields could be any of the following: Service Operation, Data Specification, Formatting Instructions, Processing Instructions, NF (or NF-Set) ID, ADRF Information, as defined in TS 23.288 R17 (V17.0.01) Clause 6.2.6.1
         Service Operation: defines the service operation to be used by NWDAF, DCCF, MFAF, or ADRF to request data (e.g.: Namf_EventExposure_Subscribe or OAM Subscribe)
         Data Specification: define any of the following, the Event IDs, Target of Event Reporting and Event Filter Information as defined in TS 23.502 [3] Clause 4.15.1, and/or the identification of the information to be retrieved from OAM, area of interest for the API data collection.
         Formatting Instructions: the parameters defined in TS 23.502 [3] clause 4.15.1 for Event Reporting Information are also part of the possible formatting and processing instructions, additionally, the following parameters may be included: Periodic bulked data notification, Time Window, Notification Event Clubbing, Processing rules.
         NF (or NF-Set) ID: defines the NFs or NF sets that are the sources for the API information defined in the Data Specification
         Another possible alternative is to include a new set of API parameters that could be any of the following:
         area of interest for the API data collection
         NF (or NF-Set) ID: defines the NFs or NF sets that are the sources for the API information defined in the Data Specification
         List of KPIs and/or metrics to be collected
         NF (or NF-Set) ID: defines the NFs or NF sets that are the sources for the API information defined in the Data Specification
   Output parameters: Subscription Correlation ID, Confirmation if activation was possible
Nnwdaf_AnalyticsTracing_Notify:
   Input parameters:
      Notification Correlation ID, so that the consumer of Nnwdaf_AnalyticsTracing_Notify can identify the subscription to tracing an analytics ID;
      Unstable Analytics Notification, and/or Inference Rollback Notification, and/or Training Rollback Notification; Notification Correlation Information in case the entity receiving the notification from the service operation Nnwdaf_AnalyticsTracing_Notify needs to send a Rollback Status Notification back to the NWDAF with Analytics Tracing capabilities
   Output parameters: None
Nnwdaf_AnalyticsTracing_RollbackStatusNotify
   Input parameters: Subscription Correlation ID and/or Notification Correlation ID, and/or Rollback Status Notification
   Output parameters: None
(2) Extensions in NWDAF services to enable an NWDAF instance only with the Analytics Monitoring Entity Capabilities: In this case, a new service needs to be defined in NWDAF in order to allow the consumer entity 300 of this service to indicate the API for an analytics ID and obtain the AiDGI and/or the UAidI. An example of this new service, operations and parameters is defined as follows.
Nnwdaf_AnalyticsMonitoring_Subscribe:
   Input parameters:
      Notification Correlation ID, which enables the consumer of the Nnwdaf_AnalyticsMonitoring_Subscribe to identify its subscription to API related to an analytics.
      Identification of the analytics (e.g., analytics ID)
      The API information, and the same possible alternatives for embodiment of API described in the service Nnwdaf_AnalyticsTracing_Subscribe are also applicable in this case.
   Output parameters: Subscription Correlation ID, Confirmation if monitoring activation was possible.
Nnwdaf_AnalyticsMonitoring_Notify:
   Input parameters:
      Notification Correlation ID, so that the consumer of Nnwdaf_AnalyticsMonitoring_Notify can identify the subscription to monitoring information about the analytics ID;
      AidGI and/or UAidI notifications
   Output parameters: None

Moreover, changes in NWDAF(AnLF) to support embodiment of the inference entity 310 in Stages 1, 2, 3, 4, and 5. Common to the first and second alternative are as follows.
(1) Configurations for analytics ID tracing activation: In this case the NWDAF is configured with the analytics ID tracing activation. The configuration for analytics ID tracing activation includes of any of the examples below:
A tuple with of analytics ID and flag with values activate/deactivate, which means that whenever the NWDAF with Analytics Tracing Entity functionality or capability receives a message related to the analytics ID (e.g., a subscription to the analytics ID) it will start the tracing of an analytics ID.
A tuple with of analytics ID, flag with values activate/deactivate, trigger condition, which means that only when the trigger conditions are present in a received message related to the analytics ID (e.g., a subscription to the analytics ID) the NWDAF with Analytics Tracing Entity functionality or capability will start the tracing of an analytics ID. Any of the examples listed below can be trigger conditions:
   Identification of the consumer (e.g., NF Type)
   Identification of the target of the analytics (e.g., UEs, group of UEs)
   Identification of an area of interest (e.g., List of TAs or Cells)
   Identification of a network slice (e.g., S-NSSAI)
   Identification of an application (e.g., Application ID)
   Identification of a data network (e.g., DNN or DNAI)
(2) Extensions of the NWDAF Subscribe/Request service operations to implement the subscription with tracing activation:
Indication of Analytics ID tracing activation: In this case the indication of analytics ID tracing activation is implemented is part of the existing NWDAF services operation to subscribe (or request) an analytics ID.
Analytics ID tracing activation: Any of the examples listed below are the new parameters being used for the analytics ID tracing activation:
   Option A: Input parameter at NWDAF services indicating to return the Unstable Analytics Notification, without executing analytics rollback actions. For instance, this would allow the Analytics Consumer to take a decision to stop the subscription to an analytics ID exposed by NWDAF; or to continue to consume it but not put so much weight on this information for its internal decision making.
   Option B: Input parameter at NWDAF services indicating to execute analytics rollback actions if possible, optionally with the notification if rollbacks happened
   Option C: Input parameter for NWDAF to performing rollback processes if possible, optionally with the APIs of interest to be used for the consumer of the analytics ID
(3) Extensions of the NWDAF Notify service to implement the Unstable Analytics Notification and/or Analytics Status Notification and/or Confirmation of Unstable Analytics Notification:
The input parameters of Nnwdaf_AnalyticsSubscription_Notify service operation can be extended with a flag that can be set to denote the Unstable Analytics Notification and/or Analytics Status Notification and/or Confirmation of Unstable Analytics Notification. This flag can be called “Analytics Status” and could have the following values: Unstable, Stable, Confirmed Unstable.
The same type of extension can be provided also for the NWDAF AnalyticsInfo_Request response, where the output parameters of this service operation are extended with the flag discussed above.
(4) Extensions of the NWDAF Notify service to implement the Reactivation.
The output parameters of Nnwdaf_AnalyticsSubscription_Notify service operation can be extended to allow the NF Consumer of NWDAF service to indicate to NWDAF whether the NF Consumer wants to be notified about a change in “Analytics Status” even when the NF Consumer un-subscribed to the analytics ID, after receiving a “Analytics Status=Unstable” or. “Analytics Status=Confirmed Unstable.” The new output parameters of Nnwdaf_AnalyticsSubscription_Notify service operation can be:
   A flag enabling the NF Consumer to activate the change of status notification: “Change Status Notification”, with values true or false, for instance.
   (Optionally) A Notification Target Address (+Notification Correlation ID), that indicates to NWDAF the address that should be used to send a next Nnwdaf_AnalyticsSubscription_Notify when the status of the analytics changes. In this case, this next Nnwdaf_AnalyticsSubscription_Notify should include as input parameters “Analytics Status=Stable” and the Notification Correlation ID provided by the NF consumer in the output parameters of Nnwdaf_AnalyticsSubscription_Notify. The changes, allow for the NF consumer to unsubscribe to an analytics ID.
(5) Extensions of the NWDAF Subscribe (or Request) service to implement the reactivation of a subscription when an analytics changes its status from unstable to stable:
This is another option to implement the reactivation of a subscription in contrast to extensions highlighted in (5).
The input parameters of Nnwdaf_AnalyticsSubscription_Subscribe (and/or Nnwdaf_AnalyticsInfo_Request) are extended to include new parameters:
   Subscription Correlation ID that denotes that a previous subscription should be reactivated
   List of analytics ID with an indication for being reactivated. Such indication can be for instance a flag called “reactivation”.
Because this is a reactivation of an analytics ID, there is no need to include the further required or optional parameters in the subscription such as Target of Analytics Reporting, Notification Target Address (+Notification Correlation ID), Analytics Reporting Parameters, Analytics target period, etc.
(6) Extensions of the NWDAF Unsubscribe service to enable the NF consumer to perform a subscription reactivation when an analytics changes its status from unstable to stable:
The input parameters of Nnwdaf_AnalyticsSubscription_Unsubscribe are extended to include new parameters:
   A flag, e.g., called Analytics Status Change Notification, that indicates that a consumer entity 330 wants to be notified about a change in the status of an analytics;
   List of Analytics ID, which indicates the analytics ID that the NF Consumer is interested in having the notification about their status change.
   A Notification Target Address (+Notification Correlation ID) that allows NWDAF to notify the consumer about the change in the analytics status, from unstable to stable analytics ID.
Additionally, extensions in Nnwdaf_AnalyticsSubscription_Notify service operation need to be done. In this case, the objective is to use the same existing service Nnwdaf_AnalyticsSubscription_Notify for indicating to a NF Consumer that unsubscribed to an analytics ID, that this NF Consumer should be able to reactivate the subscription to the analytics ID, because the status of the analytics ID change from Unstable Analytics ID to Stable Analytics ID. In this case, when the status of the analytics ID indicated in the Nnwdaf_AnalyticsSubscription_Unsubscribe service operation changed, the NWDAF will use the Nnwdaf_AnalyticsSubscription_Notify with the following parameter extensions:
   Notification Correlation ID as a required parameter in case of notification of change of analytics ID status
   List of Analytics ID with changed status.
(7) Extensions of the NWDAF Subscribe (or Request) service to implement the definition of Analytics Performance Information to be monitored:
The input parameters of Nnwdaf_AnalyticsSubscription_Subscribe (and/or Nnwdaf_AnalyticsInfo_Request) are extended to include new parameters:
   One possible alternative is to reuse the fields already defined for the Nnwdaf_DataManagement service defined in Clause 7.4.2 in TS 23.288 (V17.0.0.1) in order to include those fields into the subscription/request but to define the API information. These fields could be any of the following: Service Operation, Data Specification, Formatting Instructions, Processing Instructions, NF (or NF-Set) ID, ADRF Information, as defined in TS 23.288 R17 (V17.0.01) Clause 6.2.6.1
      Service Operation: defines the service operation to be used by NWDAF, DCCF, MFAF, or ADRF to request data (e.g.: Namf_EventExposure_Subscribe or OAM Subscribe)
      Data Specification: define any of the following, the Event IDs, Target of Event Reporting and Event Filter Information as defined in TS 23.502 [3] Clause 4.15.1, and/or the identification of the information to be retrieved from OAM, area of interest for the API data collection
      Formatting Instructions: the parameters defined in TS 23.502 [3] clause 4.15.1 for Event Reporting Information are also part of the possible formatting and processing instructions, additionally, the following parameters may be included: Periodic bulked data notification, Time Window, Notification Event Clubbing, Processing rules.
      NF (or NF-Set) ID: defines the NFs or NF sets that are the sources for the API information defined in the Data Specification
   Another possible alternative is to include a new set of API parameters that could be any of the following:
      area of interest for the API data collection
      NF (or NF-Set) ID: defines the NFs or NF sets that are the sources for the API information defined in the Data Specification
      List of KPIs and/or metrics to be collected
      NF (or NF-Set) ID: defines the NFs or NF sets that are the sources for the API information defined in the Data Specification
(8) Extensions of the NWDAF service operations to support NWDAF receiving an Indication of inference tracing activation:
One alternative is that NWDAF is enhanced with a new service operation called Nnwdaf_AnalyticsSubscription_AnalyticsTraceSubscription. This service enables the NWDAF to generating and providing the AICI for the NWDAF with Analytics Tracing Entity capabilities.
   Input parameters (any of the listed below):
      Identification of the consumer of the analytics that should be traced, for instance, this identification can be the NF ID or the Notification Correlation ID of the consumer of the analytics ID (i.e., the consumer that invoked the Nnwdaf_AnalyticsSubscription_Subscribe or Nnwdaf_AnalyticsInfo_Request).
      Identification of the analytics ID subscription.
      Identification of analytics ID
      Notification Correlation ID of the consumer of the tracing activation at NWDAF, which enables the consumer of the Nnwdaf_AnalyticsSubscription_ActivateTrace to identify its subscription to analytics tracing information at the NWDAF.
   Output parameters: Subscription Correlation ID.
Nnwdaf_AnalyticsSubscription_AnalyticsTraceNotify:
   Input parameters (any of the following):
      Notification Correlation ID, Identification of the analytics ID subscription, AICI

### Changes in NWDAF(MTLF) to Support Embodiment of Training NF in Stages 1, 2 and 3:

(1) Common to all possible extensions discussed in this part of the embodiment:
Potential alternatives to represent the set of information for an indication of re-selection or an indication of re-training is to use a flag such as “model tracing status” that can be set to “retrain” or “re-select”. Additionally, the set of information from both indications could also include the reason for the “retrain” or “re-select”. This could be implemented as another parameter such as a flag being set to “analytics stable” or “analytics unstable”.
(2) Extensions in order to NWDAF(MTLF) to receive an Unstable Analytics Notification and/or the Training Rollback Notification from an NWDAF (AnLF) or standalone NWDAF with Analytics Tracing Entity, the possible alternatives for embodiments are:
Extensions of the service offered by the NWDAF(MTLF). A new service would be Nnwdaf_MLModelTracing service. The possible operations are:
   GetTracingNotifications (request/response): Where the consumer can include in the input parameters the Unstable Analytics Notification and/or the Training Rollback Notification to the NWDAF(MTLF) together with further information such (any of the following): analytics ID, analytics stage (inference and/or training),
Extensions of the services offered by the NWDAF (AnLF) or standalone NWDAF with Analytics Tracing Entity 300, where the NWDAF(MTLF) subscribes to receive Unstable Analytics Notification and/or the Training Rollback Notification for a given ML model. The service could be Nnwdaf_AnaltyicsTracing and the operation could be of subscribe/notify where the operations and associated parameters could be:
   SubscribeTracingInfo (subscribe operation),
      Input parameters (any of the following): analytics ID, analytics stage (inference and/or training), ML model and/or model identification, the Notification Address (to enable the NWDAF(MTLF) to receive the notification), Notification Correlation ID. Additionally, the input parameters could specify which type of notification the consumer is interested in receiving: for instance, Analytics Notification, the Training Rollback Notification. If no type of notification is indicated in the subscription, the consumer will receive any type of notification that is related to the indicated ML model and/or model indicated in the subscription.
      Output parameter: subscription correlation ID.
   NotifyTracingInfo (notify operation)
      Input parameters: Notification Correlation ID (which enables the consumer to know to which ML model and/or model this notification is associated with) and the notification, for instance: Unstable Analytics Notification and/or the Training Rollback Notification
(3) Extensions in order to NWDAF(MTLF) to receive an Indication for Re-selection and/or Indication for Re-training from an NWDAF (AnLF), the possible alternatives for embodiments are:
One alternative is to define extensions of the existing service Nnwdaf_MLModelProvision_Subscribe, to include the new input parameters: Subscription correlation ID, list of analytics ID, and for each of the analytics ID the Indication for Re-selection and/or Indication for Re-training. Because this is retraining or re-selection of a model for an existing subscription to a ML model for an analytics ID, there is no need to include the further required or optional parameters in the subscription as defined in Clause 7.5.2 in TS 23.288 (V17.0.1).
Another alternative is to also use the above mentioned service Nnwdaf_MLModelTacing_GetTracingNotifications (request/response) to also enable the NWDAF (AnLF) to send to the NWDAF(MTLF) the Indication for Re-selection and/or Indication for Re-training
(4) Extensions in Nnwdaf_MLModelProvision service from NWDAF(MTLF) in order to NWDAF(MTLF) to provide to an NWDAF (AnLF) or to other NWDAF(MTLF) the Unstable Analytics Notification and/or Confirmation Unstable Analytics Notification or Training Rollback Information or Analytics Status Notification, which is related to a ML model and/or model that has been previously consumed by such NWDAF (AnLF):
One possible extension is to allow the consumer of the Nnwdaf_MLModelProvision_Subscribe service, NWDAF (AnLF) and/or other NWDAF(MTLF) to indicate in the subscription to a ML model and/or model for an analytics, the intention of receiving Unstable Analytics Notification and/or Confirmation Unstable Analytics Notification or Training Rollback Information or Analytics Status Notification together with the notification. In this case, the Nnwdaf_MLModelProvision_Subscribe service input parameters can be extended with any of the following parameters:
   Current ML model and/or model identification (i.e., the model that is being currently in use);
   Analytics identification (e.g., Analytics ID) associated with the ML model and/or model being used;
   Flag indicating the current model is related to an unstable analytics ID
   Flag indicating the confirmation of current model is related to an unstable analytics ID
   Flag indicating a new model is required
   Flag indicating the confirmation of current model being stable
   The Rollback Training Information (e.g., the information including the Rollback Training Information)
Another alternative is to create a dedicated service
(5) In order to provide a Training Rollback Information to Inference NFs and/or other Training NFs that consumed the ML model and/or model, the possible alternatives for embodiments are:
Extensions of the service operations for notifying about a subscribed/requested model, to include any of the following parameters as being information further related to the Training Rollback Information:
   Identification of current ML model and/or model being used;
   Analytics ID,
   Identification of the changed ML model and/or model;
Changed ML model and/or model information (e.g., any of the following information: gradients, algorithms, weights, model architecture, among others);
Flag indicating the current model is related to an unstable analytics ID
ML model and/or model script and/or file and/or configuration with the changes
(6) Extensions of the NWDAF service operations to support NWDAF receiving an Indication of Training tracing activation:
One alternative is that NWDAF is enhanced with a new service operation called Nnwdaf_MLModelProvision_AnalyticsTraceSubscription. This service enables the NWDAF to generating and providing the AICI for the NWDAF with Analytics Tracing Entity capabilities.
   Input parameters (any of the listed below):
      Identification of the consumer of the ML model and/or model for the analytics (e.g., analytics ID) that should be traced, for instance, this identification can be the NF ID or the Notification Correlation ID of the consumer of the ML model and/or model being provisioned for the analytics ID (i.e., the consumer that invoked the Nnwdaf_MLModelProvision_Subscribe).
      Identification of the ML model and/or model subscription.
      Identification of analytics ID
      Identification of the ML model and/or model
      Notification Correlation ID of the consumer of the tracing activation at NWDAF, which enables the consumer of the Nnwdaf_MLModelProvision_AnalyticsTraceSubscription to identify its subscription to analytics tracing information at the NWDAF.
   Output parameters: Subscription Correlation ID.
Nnwdaf_MLModelProvision_AnalyticsTraceNotify:
   Input parameters (any of the following):
      Notification Correlation ID, Identification of the ML model and/or model for analytics ID subscription, ATCI
   Output parameters: None

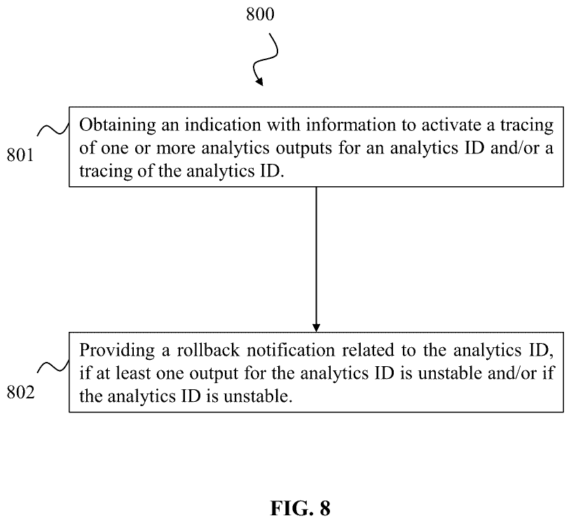

FIG. 8 shows a method 800 according to an embodiment. The method 800 is for a network analytics tracing entity 300 as described above and may be performed by the tracing entity 300. The method 800 includes a step 801 of obtaining an indication 301 with information to activate a tracing of one or more analytics outputs for an analytics ID and/or a tracing of the analytics ID. Further, a step 802 of providing a rollback notification 302 related to the analytics ID, if at least one output for the analytics ID is unstable and/or if the analytics ID is unstable.

The rollback notification 302 includes one or more of:
The at least one unstable analytics output for the analytics ID and/or the analytics ID, where the rollback notification 302 is provided to a network analytics consumer entity 330, a network analytics inference entity 310, or a network analytics training entity 320;
An inference rollback action 311 for the at least one unstable analytics output for the analytics ID and/or for the analytics ID, where the rollback notification 302 is provided to the network analytics inference entity 310;
A training rollback action 321 for the at least one unstable analytics output for the analytics ID and/or for the analytics ID, where the rollback notification 302 is provided to the network analytics training entity 320.

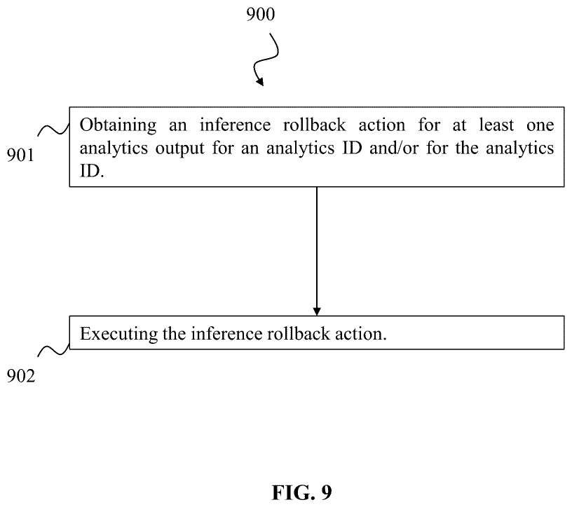

FIG. 9 shows a method 900 according to an embodiment. The method 900 is for a network analytics inference entity 310 and may be performed by the inference entity 310. The method 900 includes a step 901 of obtaining an inference rollback action 311 for at least one analytics output for an analytics ID and/or for the analytics ID. Further, the method 900 includes a step 902 of executing the inference rollback action 311.

Executing the inference rollback action 311 includes at least one of:
Changing an inference configuration about the at least one analytics output for the analytics ID and/or about the analytics ID;
Determining and setting a new inference configuration about the at least one output for the analytics ID and/or about the analytics ID;
Selecting a new analytics model for the at least one analytics output for the analytics ID and/or for the analytics ID;
Deactivating an analytics model for the at least one analytics output for the analytics ID and/or for the analytics ID.

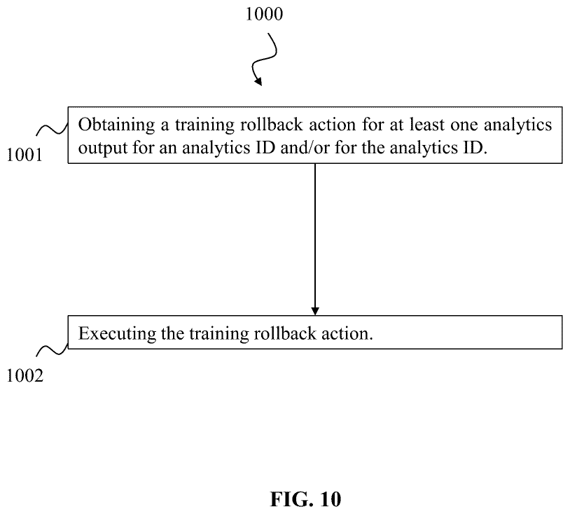

FIG. 10 shows a method 1000 according to an embodiment. The method 100 is for a network analytics training entity 320 and may be performed by the training entity 320. The method 1000 includes a step 1001 of obtaining a training rollback action 321 for at least one analytics output for an analytics ID and/or for the analytics ID. Further, the method 1000 includes a step 1002 of executing the training rollback action 321.

Executing 1002 the training rollback action 321 includes at least one of:
Changing a training configuration about the at least one analytics output for the analytics ID and/or about the analytics ID;
Selecting and setting a new training configuration about the at least one analytics output for the analytics ID and/or about the analytics ID;
Performing a retraining or a reselection of an analytics model for the at least one analytics output for the analytics ID and/or for the analytics ID;
Deactivating an analytics model for the at least one analytics output for the analytics ID and/or for the analytics ID.

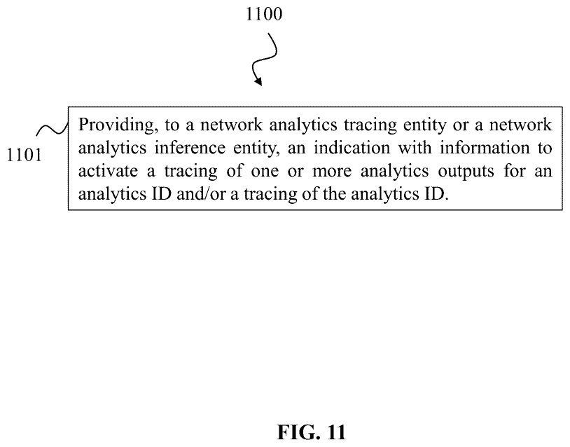

FIG. 11 shows a method 1100 according to an embodiment. The method 1100 is for a network data analytics consumer entity 330 and may be performed by the consumer entity 330. The method 1100 includes a step 1101 of providing, to a network analytics tracing entity 300 or a network analytics inference entity 310, an indication 301 with information to activate a tracing of one or more analytics outputs for an analytics ID and/or a tracing of the analytics ID.

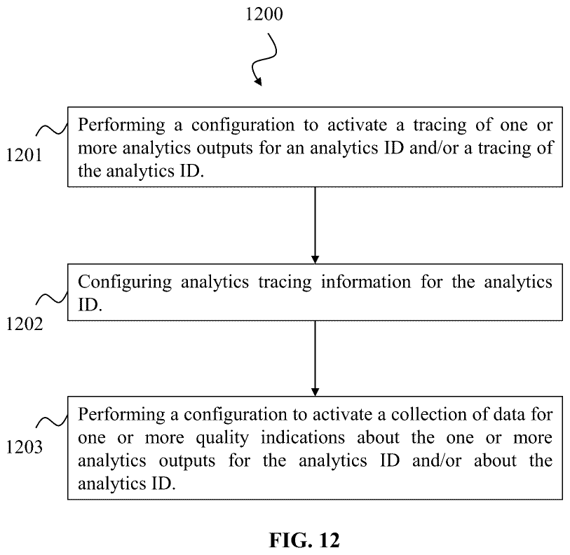

FIG. 12 shows a method 1200 according to an embodiment. The method 1200 is for a network analytics management entity 340 and may be performed by the management entity 340. The method 1200 includes a step 1201 of performing a configuration 341 to activate a tracing of one or more analytics outputs for an analytics ID and/or a tracing of the analytics ID. Additionally or alternatively, the method 1200 includes a step 1202 of configuring analytics tracing information 403 for the analytics ID. Additionally or alternative, the method 1200 includes a step 1203 of performing a configuration 341 to activate a collection of data for one or more quality indications about the one or more analytics outputs for the analytics ID and/or about the analytics ID.

The embodiments have been described in conjunction with examples as well as implementations. However, other variations can be understood and effected by those persons skilled in the art, from the studies of the drawings and the embodiments

1. A method comprising:
obtaining an indication with information to activate a tracing of one or more analytics outputs for at least one of an analytics identifier (ID) and a tracing of the analytics ID; and
providing a notification related to the analytics ID when at least one output for the analytics ID is unstable or when the analytics ID is unstable, wherein the notification comprises one or more of:
a first analytics notification for the at least one unstable analytics output for the analytics ID,
a second analytics notification for the analytics ID;
a first inference notification for the at least one unstable analytics output for the analytics ID;
a second inference notification for the analytics ID;
a first training notification for the at least one unstable analytics output for the analytics;
a second training notification for the analytics ID:
wherein one or more the first analytics notification and the second analytics notification is provided to a network analytics consumer entity, a network analytics inference entity, or a network analytics training entity;
where one or more of the first inference notification and the second inference notification is provided to the network analytics inference entity;
where one or more of the first training notification and the second training notification is provided to the network analytics training entity.

2. The method according to claim 1, further comprising:
creating analytics tracing information associated with the analytics ID.

3. The method according to claim 2, where the analytics tracing information associated with the analytics ID comprises an analytics tracing data structure (ATDS).

4. The method according to claim 3, where the ATDS comprise an ATDS of the analytics ID- or an ATDS for the analytics ID.

5. The method according to claim 3, where the ATDS is associated to a time analytics tracing information record for the analytics ID.

6. The method according to claim 3, where the ATDS comprises a historical set of ADTS records.

7. The method according to claim 3, where the ATDS comprises an ATDS record indicating a network state at a given point in time when using a given analytics.

8. The method according to claim 7, where the given analytics comprises one or more of:
the analytics ID,
an analytics type, or
one or more analytics outputs.

9. The method according to claim 1, where the notification comprises one or more information associated with one or more of:
an unstable analytics ID,
an unstable analytics output associated with the analytics ID.

10. The method according to claim 9, where the notification comprises one or more of:
an ATDS record with the analytics inference configuration information (AICI) and/or analytics training configuration information (ATCI) for the analytics ID of the ATDS record that has been considered as the unstable analytics ID;
a parameter such as tuple with the identification of the analytics ID and/or analytics output and a flag, where this flag denotes that there is a problem (or an error) with one or more of the analytics ID and output(s).

11. The method according to claim 10, where the flag comprises one or more of:
unstable analytics,
halt analytics usage,
invalid analytics, or
temporary invalid analytics.

12. The method according to claim 10, where the unstable analytics ID indicates that there is a problem (and/or an error) with the analytics ID and/or analytics outputs.

13. The method according to claim 1, where the method is applied to a network data analytics function (NWDAF) containing analytics logical function (AnLF).

14. The method according to claim 1, further comprising:
tracing the one or more analytics outputs for the analytics ID and/or tracing the analytics ID, based on the indication with the information to activate the tracing; and
provide the notification based on one or more of the tracing of the one or more analytics outputs for the analytics ID, and the analytics ID.

15. The method according to claim 14, further comprising:
receiving a status notification, wherein the status notification comprises at least one of a status of the inference action for the network analytics inference entity and a status of the training action for the network analytics training entity.

16. The method according to claim 1, further comprising:
providing at least one of the following:
an analytics status notification indicating at least one of that the one or more analytics outputs for the analytics ID are stable and that the analytics ID is stable;
a confirmation that the at least one unstable analytics output for the analytics ID is unstable;
an inference tracing activation indication with information to activate a tracing of an inference configuration about one or more of: at least one of the one or more analytics outputs for the analytics ID, and the analytics ID;
a training tracing activation indication with information to activate a tracing of a training configuration about one or more of: at least one of the one or more analytics outputs for the analytics ID, and the analytics ID.

17. The method according to claim 1, further comprising:
generating analytics tracing information for one or more of: the one or more analytics outputs for the analytics ID, and for the analytics ID and to determine the inference rollback action and/or the training rollback action based on the analytics tracing information, wherein the analytics tracing information comprises one or more of the following:
the analytics ID,
an association of the analytics ID to the one or more analytics outputs for the analytics ID,
one or more quality indications about one or more of: at least one of the one or more analytics outputs for the analytics ID, and the analytics ID,
an inference configuration about the analytics ID and/or about the one or more analytics outputs for the analytics ID,
a training configuration about the analytics ID and/or about the one or more analytics outputs for the analytics ID.

18. The method according to claim 17, wherein the analytics tracing information further comprises at least one of a status of the inference action, a status of the training action, one or more inference actions, and one or more training actions associated with the analytics ID and/or associated with one or more analytics outputs for the analytics ID.

19. An apparatus comprising a circuit for:
obtaining an indication with information to activate a tracing of one or more analytics outputs for an analytics identifier, ID, and/or a tracing of the analytics ID; and
providing a notification related to the analytics ID, when at least one output for the analytics ID is unstable and/or if the analytics ID is unstable, wherein the notification comprises one or more of:
the at least one unstable analytics output for the analytics ID and/or the analytics ID, wherein the notification is provided to a network analytics consumer entity, a network analytics inference entity, or a network analytics training entity;
an inference notification for the at least one unstable analytics output for the analytics ID and/or for the analytics ID, wherein the notification is provided to the network analytics inference entity;
a training notification for the at least one unstable analytics output for the analytics ID and/or for the analytics ID, wherein the notification is provided to the network analytics training entity.

20. A non-transitory storage apparatus comprising a program or instruction, which when executed by a computer, to enable the computer to perform:
obtaining an indication with information to activate a tracing of one or more analytics outputs for at least one of an analytics identifier (ID), and a tracing of the analytics ID; and
providing a notification related to the analytics ID, when at least one output for the analytics ID is unstable or if the analytics ID is unstable, wherein the notification comprises one or more of:
a first analytics notification for the at least one unstable analytics output for the analytics ID;
a second analytics notification for the analytics ID;
a first inference notification for the at least one unstable analytics output for the analytics ID;
a second inference notification for the analytics ID;
a first training notification for the at least one unstable analytics output for the analytics ID;
a second training notification for the analytics ID;
wherein one or more the first analytics notification and the second analytics notification is provided to a network analytics consumer entity, a network analytics inference entity, or a network analytics training entity;
where one or more of the first inference notification and the second inference notification is provided to the network analytics inference entity;
where one or more of the first training notification and the second training notification is provided to the network analytics training entity.
